(19) United States
(12) Patent Application Publication
(10) Pub. No.: US 2013/0276519 A1
(43) Pub. Date: Oct. 24, 2013

(54) Methods of Separating Compounds

(71) Applicants: Dmitry V. Uborsky, Moscow (RU); Alexander Z. Voskoboynikov, Moscow (RU); Hasnain Rangwalla, Katy, TX (US); Jo Ann M. Canich, Houston, TX (US)

(72) Inventors: Dmitry V. Uborsky, Moscow (RU); Alexander Z. Voskoboynikov, Moscow (RU); Hasnain Rangwalla, Katy, TX (US); Jo Ann M. Canich, Houston, TX (US)

(21) Appl. No.: 13/452,429

(22) Filed: Apr. 20, 2012

(51) Int. Cl. G01N 1/34

(52) U.S. Cl. CPC G01N 1/34
USPC 73/61.55

(57) ABSTRACT

Methods for chromatography for metal compounds are disclosed herein. These methods relate to introducing an analyte solution into a chromatographic system comprising a liquid phase flowing through a solid stationary phase, wherein the solid stationary phase comprises graphitic carbon; and eluting compounds from the stationary phase with a retention factor greater than zero, wherein a chromatogram of the eluted compounds shows that the compounds are substantially resolved. Methods for determining the purity of mixtures of metal compounds are also disclosed.

### FIELD OF THE INVENTION

This invention relates to methods for the separation of metal compounds, particularly organometallic compounds and organometalloid halides.

### BACKGROUND OF THE INVENTION

Compounds comprising metals, for example, organometallic compounds, display diverse chemical, optical, and magnetic properties, and have demonstrated tremendous utility in catalysis, materials synthesis, photochemistry, and as possible therapeutic agents. The synthesis of these useful compounds often leads to a mixture of species, including residual starting materials, salts, product, and sometimes isomers, such as diastereomers, of the desired product. Separation procedures are often carried out to remove unreacted reagents or side products. Many methods have become standard for these purifications, including gravity column chromatography, thin layer chromatography, and high performance liquid chromatography (HPLC).

However, separation of some metal-containing compounds remains a challenge. For example, separation of mixtures of isomers of metallocenes is often a difficult process involving repeated crystallizations and separations. Other challenging separations include those of metallic compounds that are unstable in a protic environment. Yet other challenges are presented by mixtures of isomers of organometallic compounds. Advances in techniques for such separations by ion chromatography, normal and reversed phase HPLC, and thin layer chromatography methods are often limited by the availability of an appropriate support material. Traditional chromatography columns often contain column packing materials that make them incompatible with these complexes because of reactivity with the complex or due to complex decomposition. In other cases, the complex may bind irreversibly to the column or may not be retained sufficiently on the column to allow separation. This belies one of the most desirable features of a stationary phase, that is good adsorption and good desorption characteristics.

A reference of interest is “Porous Graphitic Carbon (PGC) High-Performance Liquid Chromatography of Diphosphine-Bridged Complexes with Heteronuclear Au-M (M=Mn, Re) bonds,” Li, C. H.; Low, P. M. N.; Li, S.; Lee, K. H.; Hor, T. S. A.; Chromatographia (1997), 44(7/8), pp. 381-385, where the isocratic high-performance liquid chromatography of 1,1′-bis(diphenylphosphino)ferrocene (dppf), 1,1′-bis(diphenylphosphino)ruthenocene (dppr), bis(di-phenylphosphino)methane (dppm) and triphenylphosphine (PPh₃)-substituted heterometallic Au—Mn or Au—Re carbonyl complexes was reported. Specifically, a column packed with PGC (porous graphitic carbon) was used after preliminary experiments had shown that silica- and bonded-phase (silica-based) stationary phases were unsatisfactory for separation. The PGC column exhibited unique selectivity for the complexes studied. The mobile phases used were water-acetonitrile, dichloromethane-hexane and tetrahydrofuran-hexane. The retention behavior of the compounds was governed by the polar character and size of molecules, and influenced by metal-metal bond polarity. Separation of isomorphous structures with different metallocenyl moieties was achieved. However, separation of compounds unstable in protic environments is not disclosed.

Other references of interest include JP 11-080184; WO 2007071370; Journal of Chromatography A, 1997, Vol. 789, pp. 437-451; Journal of Liquid Chromatography, Vol. 14, No. 11, pp. 2079-2087; Journal of Liquid Chromatography, Vol. 17, No. 17, pp. 3671-3680; Journal of Organometallic Chemistry, 476, (1994), pp. 127-132; Chemical Communications 1969, pp. 1304, 1306-1307; and Chemical Reviews, 1989, pp. 407-418.

Accordingly, there is a need for improved methods for the separation of metal-containing compounds, particularly those that are not easily separated using conventional chromatography techniques and/or those unstable in a protic environment.

### SUMMARY OF THE INVENTION

This invention relates to methods for chromatography comprising: introducing an analyte solution comprising protically unstable compounds into a chromatographic system comprising a liquid phase flowing through a solid stationary phase, wherein the solid stationary phase comprises graphitic carbon; and eluting compounds from the stationary phase with a retention factor greater than zero, wherein a chromatogram of the eluted compounds shows that the compounds are substantially resolved.

This invention also relates to methods for chromatography comprising: introducing an analyte solution comprising a transition metal compound from groups 3 to 6 into a chromatographic system comprising a liquid phase flowing through a solid stationary phase, wherein the solid stationary phase comprises graphitic carbon; and eluting compounds from the stationary phase with a retention factor greater than zero, wherein a chromatogram of the eluted compounds shows that the compounds are substantially resolved.

This invention further relates to methods for determining the purity of an analyte solution comprising: introducing an analyte solution into a chromatographic system comprising a liquid phase flowing through a solid stationary phase, wherein the analyte solution comprises a transition metal from groups 3 to 12 and/or a metalloid from groups 13 to 16 and/or a lanthanide metal, and wherein the solid stationary phase comprises graphitic carbon; eluting compounds from the stationary phase with a retention factor greater than zero, wherein a chromatogram shows that the eluted compounds have a resolution of greater than 1.0; and determining the amount of the desired compound.

### BRIEF DESCRIPTION OF THE DRAWINGS

FIG. 1 is a representation of the surface of C₁₈ modified silica (1-A) and graphitic carbon (1-B).

FIG. 2 is a chromatogram of 2-methyl-7-bromoindene, separated according to the methods disclosed herein.

FIG. 3 is a chromatogram of bis(2-methyl-4-bromoindenyl)dimethylsilane, separated according to the methods disclosed herein.

FIG. 4 is a chromatogram of dimethylsilylene-bis(2-methyl-4-bromoindenyl) zirconium dichloride, showing decomposition products.

FIG. 5 is a chromatogram of (2,4,6-trimethylindenyl)(3-methyl-1-n-butylcyclopentadienyl)zirconium dichloride, separated according to the methods disclosed herein.

FIG. 6 is a chromatogram of bis(4,5-dimethyl-cyclopenta[b]thienyl)zirconium dichloride, separated according to the methods disclosed herein.

FIG. 7 is a chromatogram of bis(5,6-dimethyl-cyclopenta[b]thienyl)zirconium dichloride, separated according to the methods disclosed herein.

FIG. 8 is a chromatogram of a 1:1 mixture of rac- and meso-dimethylsilylene-bis(2-methyl-4-phenylindenyl)zirconium dichloride, separated using a comparative chromatography column.

FIG. 9 is a chromatogram of a 1:1 mixture of rac- and meso-dimethylsilylene-bis(2-methyl-4-phenylindenyl)zirconium dichloride, separated using a comparative chromatography column.

FIG. 10 is a chromatogram of a 1:1 mixture of rac- and meso-dimethylsilylene-bis(2-methyl-4-phenylindenyl)zirconium dichloride, separated using a comparative chromatography column.

FIG. 11 is a chromatogram of a mixture of [N-(tert-butyl)-1,1-dimethylsilanaminato-(2,4-dimethylinden-1-yl)]titanium dichloride and [N-(tert-butyl)-1,1-dimethylsilanaminato-(2-methyl-4-(p-tolyl)inden-1-yl)]titanium dichloride, separated according to the methods disclosed herein.

FIG. 12 is a chromatogram of a mixture of 2′,2″-[pentane-2,4-diylbis(oxy)]bis[3-(9H-carbazol-9-yl)-5-methylbiphenyl-2-oxy]hafnium dichloride, separated according to the methods disclosed herein.

FIG. 13 is a chromatogram of [N-[2,6-bis(1-methylethyl)phenyl]-α-[2-(1-methylethyl)phenyl]-6-(1-naphthalenyl-κC2)-2-pyridinemethanaminato(2-)-κN1,κN2]-dimethylhafnium, separated according to the methods disclosed herein.

FIG. 14 is a chromatogram of neodymium tris(hexamethyldisilazide), separated according to the methods disclosed herein.

FIG. 15 is a chromatogram of N-bis[bis(2-methoxyphenyl)phosphino]methylamino chromium trichloride, separated according to the methods disclosed herein.

FIG. 16 is a chromatogram of a mixture of 2-methyl-4-bromoindene and (2-methylindene-7-yl)dimethylchlorosilane, separated according to the methods disclosed herein.

FIG. 17 is a chromatogram of a mixture of rac- and meso-dimethylsilylene-bis(2-methyl-4-phenylindenyl)zirconium dichloride (benzene, 1 ml/min), separated according to the methods disclosed herein.

FIG. 18 is a chromatogram of (N¹,N³-diphenyl-1,3-propanediamido)bis (tetrahydrofurano)zirconium dichloride (CH₂Cl₂/toluene=1:1, 2 ml/min), separated according to the methods disclosed herein.

FIG. 19 is a chromatogram of (1,3-bis(2,6-diisopropylphenyl)imidazol-2-ylidene) (triphenylphoshino)nickel dichloride (toluene, 1 ml/min), separated according to the methods disclosed herein.

FIG. 20 is a chromatogram of a mixture of PhPCl₂ and Ph₂PCl, separated according to the methods disclosed herein, where Ph is phenyl.

FIG. 21 is a chromatogram of a mixture of toluenesulfonyl chloride and 2,4,6-triisopropylphenylsulfonyl chloride, separated according to the methods disclosed herein.

FIG. 22 is a chromatogram of a mixture of 4-tert-butylbenzoyl chloride and 2-bromobenzoyl chloride, separated according to the methods disclosed herein.

### DETAILED DESCRIPTION

High Performance Liquid Chromatography (HPLC) is a powerful tool in the separation and analysis of compounds, and has gained popularity in the separation of organometallic compounds. HPLC is an improved form of the traditional column chromatography where instead of a solvent (liquid phase) being allowed to drip onto a column (solid phase) under gravity or low pressure, the liquid phase is forced through a solid stationary phase under high pressures. It is characterized by high speed and efficiency and can be coupled to very sensitive small-volume liquid phase detectors. Additionally, analyses are performed rapidly, using degassed solvents, stainless steel columns, and light exclusion, all of which make HPLC particularly suited for organometallic mixtures characterized by oxidative, thermal, or photochemical instability.

In order to have a successful HPLC, it is important to select an appropriate stationary phase and an appropriate mobile liquid phase. In normal phase HPLC, compounds are separated based on their affinity for a polar stationary phase, such as silica. This method is based on the compound's ability to engage in polar interactions (such as hydrogen-bonding or dipole-dipole type of interactions) with the surface of the stationary phase. Normal phase HPLC uses a non-polar, non-aqueous mobile phase, and works effectively for separating compounds that are readily soluble in non-polar solvents. Reversed phase HPLC has become a very common liquid chromatographic mode, wherein the stationary phase, typically silica, is modified to make it non-polar by attaching long hydrocarbon chains to its surface, typically with either 8 or 18 carbon atoms in them. A polar liquid phase is used. This allows for easy separation of polar and non-polar compounds. However, conventional reversed phase HPLC chromatographic system does not adequately separate compound that are similar in polarity to each other, such as diastereomers, nor does it allow for the separation of compounds that are unstable in a protic environment.

The inventors have surprisingly discovered chromatography methods that utilize a stationary phase comprising graphitic carbon, for example, columns packaged with porous graphitic carbon or some solid carrier coated with porous graphitic, under certain conditions thereby allowing the separation of compounds on a preparative scale. The compounds are advantageously separated from reaction mixtures including salts or other undesired side products, with high speed and efficiency. Advantageously, compounds that could not be efficiently separated using conventional HPLC methods can be readily separated using these inventive methods. Such compounds include protically unstable compounds, in addition to protically stable compounds comprising a transition metal compounds from groups 3 to 6.

Accordingly, embodiments of the present invention relate to methods for chromatography comprising: introducing an analyte solution comprising protically unstable compounds into a chromatographic system comprising a liquid phase flowing through a solid stationary phase, wherein the solid stationary phase comprises graphitic carbon; and eluting compounds from the stationary phase with a retention factor greater than zero, wherein a chromatogram of the eluted compounds shows that the compounds are substantially resolved.

Other embodiments of the present invention also relate to methods for chromatography comprising: introducing an analyte solution comprising compounds comprising a transition metal from groups 3 to 6 into a chromatographic system comprising a liquid phase flowing through a solid stationary phase, wherein the solid stationary phase comprises graphitic carbon; and eluting compounds from the stationary phase with a retention factor greater than zero, wherein a chromatogram of the eluted compounds shows that the compounds are substantially resolved.

Yet other embodiments of the present invention relate to methods for determining the purity of an analyte solution comprising: introducing an analyte solution into a chromatographic system comprising a liquid phase flowing through a solid stationary phase, wherein the analyte solution comprises a transition metal from groups 3 to 12 and/or a metalloid from groups 13 to 16, and/or a lanthanide metal, and wherein the solid stationary phase comprises graphitic carbon; eluting compounds from the stationary phase with a retention factor greater than zero, wherein a chromatogram shows that the eluted compounds have a resolution of greater than 1.0; determining the amount of the desired compound; and expressing the amount of the desired compound as a percentage yield.

The new notation for the Periodic Table groups is used herein, as described in Chemical and Engineering News, 63(5), 27 (1985).

### Analytes and Preparation for Chromatography

As used herein, “analyte” refers to the compound of interest or mixture of compounds of interest to be analyzed by injection into and elution from an HPLC column. The analyte may alternatively be referred to as the sample.

Analytes may be protically stable or protically unstable. “Protically unstable” refers to a compound that decomposes in the presence of an environment that provides an acidic proton. For example, if water is present and the compound is unstable in the presence of water, the compound is considered to be protically unstable, because water has an acidic proton. Accordingly, hydrolytically unstable compounds are considered to be protically unstable for the purposes of this invention. Decomposition of a metal containing analyte refers to bond cleavage between a metal and a ligand and/or formation of one or more new metal-oxygen bonds. Decomposition may be confirmed by methods known in the art, such as by observing peak shift or new peak emergence (for example, a hydroxyl peak) in ¹H NMR, or by observing a loss of a peak at the expected retention volume in HPLC. Conversely, “protically stable” refers to a compound that does not decompose in the presence of an environment that provides an acidic proton.

In some embodiments herein, the analyte solution comprises protically unstable compounds (preferably comprising transition metal compounds from groups 3 to 12 and/or metals from groups 1 and 2, and/or metalloid compounds from groups 13 to 16, and/or lanthanide metals). “Metalloid” as used herein refers to elements that have properties in-between metals and nonmetals and includes B, Si, Ge, As, Sb, and Te.

“Diastereomers” are stereoisomers that have different configurations at one or more (but not all) of the equivalent (related) stereocenters, and are not mirror images of one another.

The terms “hydrocarbyl radical,” “hydrocarbyl” and “hydrocarbyl group” are used interchangeably throughout this document. Likewise the terms “group,” “radical”, and “substituent” are also used interchangeably in this document. For purposes of this disclosure, “hydrocarbyl radical” is defined to be a radical, which contains hydrogen atoms and up to 100 carbon atoms and which may be linear, branched, or cyclic, and when cyclic, mono-cyclic or polycyclic, and aromatic or non-aromatic.

“Substituted hydrocarbyl radicals” are radicals in which at least one hydrogen atom has been substituted with at least one functional group such as NR*₂, OR*, SeR*, TeR*, PR*₂, AsR*₂, SbR*₂, SR*, BR*₂, SiR*₃, GeR*₃, SnR*₃, PbR*₃, and the like or where at least one non-hydrocarbon atom or group has been inserted within the hydrocarbyl radical, such as —O—, —S—, —Se—, —Te—, —N(R*)—, ═N—, —P(R*)—, ═P—, —As(R*)—, ═As—, —Sb(R*)—, ═Sb—, —B(R*)—, ═B—, —Si(R*)₂—, —Ge(R*)₂—, —Sn(R*)₂—, —Pb(R*)₂—, and the like, where R* is independently a hydrocarbyl or halocarbyl radical, and wherein the substituted hydrocarbyl radical which contains hydrogen atoms and up to 100 non-hydrogen atoms and which may be linear, branched, or cyclic, and when cyclic, mono-cyclic or polycyclic, and aromatic or non-aromatic.

Halocarbyl radicals are radicals in which one or more hydrocarbyl hydrogen atoms have been substituted with at least one halogen (e.g., F, Cl, Br, I) or halogen-containing group (e.g., CF₃).

The term “arene” is used herein to mean an unsaturated cyclic hydrocarbyl group that can consist of one ring, or two or more fused or catenated rings.

The term “heteroarene” is used herein to mean an unsaturated cyclic substituted hydrocarbyl group that can consist of one ring, or two or more fused or catenated rings.

As used herein, the term “alkyl” includes straight, branched and cyclic alkyl groups.

Protically unstable compounds useful herein include compounds comprising a transition metal from groups 3 to 12 or lanthanide metal (preferably transition metals from groups 3 to 6, preferably groups 3 to 5, preferably group 4). In preferred embodiments, the protically unstable compounds comprise at least one transition metal selected from the group consisting of Sc, Y, Ti, Zr, Hf, V, Nb, Ta, and Cr (preferably Sc, Y, Ti, Zr, Hf, V, Nb, and Ta; preferably Ti, Zr, and Hf).

Compounds for use herein include complexes of transition metals selected from groups 3 to 12 or lanthanide metals containing one or more delocalized, π-bonded ligands or polyvalent Lewis base ligands.

Examples include metallocenes which include complexes containing one or more cyclopentadienyl type ligand, and chelate complexes including polyvalent pyridylamine or other polychelating base complexes. The complexes are generically depicted by the formula:

MK′ₖXₓZ_{z}

or a dimer thereof, wherein
M is a metal selected from groups 3-12 and the lanthanide metals, more preferably from groups 3-6, even more preferably from group 3-5, and most preferably from group 4 of the Periodic Table of the Elements;
K′ independently each occurrence is a group containing delocalized π-electrons or one or more electron pairs through which K′ is bonded to M, said K′ group containing up to 100 atoms not counting hydrogen atoms, optionally two or more K′ groups may be joined together forming a bridged structure, and further optionally one or more K′ groups may be bonded to Z, to X, or to both Z and X;
X independently each occurrence is a monovalent, anionic ligand having up to 50 non-hydrogen atoms, optionally two or more X groups may be bonded together thereby forming a divalent or polyvalent anionic group, and, further optionally, one or more X groups and one or more Z groups may be bonded together thereby forming a ligand that is both covalently bonded to M and coordinated thereto;
Z independently each occurrence is a neutral, Lewis base donor ligand of up to 50 non-hydrogen atoms containing at least one unshared electron pair through which Z is coordinated to M;
k is a number from 1 to 3 (preferably 1, 2, or 3);
x is a number from 0 to 4 (preferably 0, 1, 2, 3, or 4);
z is a number from 0 to 3 (preferably 0, 1, 2, or 3);
c is the absolute value of the formal charge on K′ and is 0, 1, 2, 3, or 4; and
the sum, (k×c)+x, is equal to the formal oxidation state of M.

Suitable metal complexes include those containing from 1 to 3 π-bonded anionic or neutral ligand groups, which may be cyclic or non-cyclic delocalized-bonded anionic ligand groups. Exemplary of such π-bonded groups, K′, are conjugated or nonconjugated, cyclic or non-cyclic diene and dienyl groups, allyl groups, arene and arenyl groups, and heteroarene and heteroarenyl groups such as, boratabenzene groups, cylopenta[b]thienyl groups, and phospholes. By the term “π-bonded” is meant that the ligand group is bonded to the transition metal by a sharing of electrons from a partially delocalized π-bond.

Each atom in the delocalized-bonded group may independently be substituted with a radical selected from the group consisting of hydrogen, halogen, hydrocarbyl, halocarbyl, and substituted hydrocarbyls, and such hydrocarbyl, halocarbyl, and substituted hydrocarbyl radicals may be further substituted with a group 15 or 16 heteroatom containing moiety. In addition two or more such radicals may together form a fused ring system, including partially or fully hydrogenated fused ring systems, or they may form a metallocycle with the metal. Included within the term “hydrocarbyl” are C₁₋₁₀₀ straight, branched and cyclic alkyl radicals, C₆₋₁₀₀ aromatic radicals, C₇₋₁₀₀ alkyl-substituted aromatic radicals, and C₇₋₁₀₀ aryl-substituted alkyl radicals.

Examples of suitable anionic, delocalized π-bonded groups, K′, include cyclopentadienyl, indenyl, fluorenyl, tetrahydroindenyl, tetrahydrofluorenyl, octahydrofluorenyl, pentadienyl, cyclohexadienyl, dihydroanthracenyl, hexahydroanthracenyl, decahydroanthracenyl, cyclopenta[b]thienyl, phosphole, and boratabenzyl groups, as well as substituted derivatives thereof, especially C₁₋₁₀ hydrocarbyl-substituted or tris(C₁₋₁₀ hydrocarbyl)silyl-substituted derivatives thereof.

Preferred anionic delocalized π-bonded groups, K′, are cyclopentadienyl, pentamethylcyclopentadienyl, tetramethylcyclopentadienyl, 3-methyl-1-n-butylcyclopentadienyl, indenyl, 2,4,6-trimethylindenyl, 2,4-dimethylindenyl, fluorenyl, 2-methylindenyl, 2-methyl-4-phenylindenyl, 2-isopropyl-4-(1,1′-biphen-2-yl)indenyl, 2-methyl-4-bromoindenyl, 2-methyl-4-(o-tolyl)indenyl, 2-methyl-4-(p-tolyl)indenyl, 2-methyl-4,6-diisopropylindenyl, 2,5-dimethyl-4-(3,5-di-trifluoromethylphen-1-yl)indenyl, 2,6-dimethyl-4-(3,5-di-trifluoromethylphen-1-yl)indenyl, tetrahydrofluorenyl, 1-indacenyl, cyclopenta[b]thienyl, 4,5-dimethylcyclopenta[b]thienyl and 5,6-dimethylcyclopenta[b]thienyl.

Preferred complexes include those containing either one or two K′ groups. The latter complexes include those containing a bridging group linking the two K′ groups. Preferred bridging groups are those corresponding to the formula (ER″₂)ₑ wherein E is silicon, germanium, tin, or carbon, R″ independently each occurrence is hydrogen or a group selected from, hydrocarbyl, halocarbyl, or substituted hydrocarbyl, said R″ having up to 30 non-hydrogen atoms, and e is 1 to 8 (preferably 1, 2, 3, 4, 5, 6, 7, or 8). Preferably, R″ independently each occurrence is methyl, ethyl, propyl, benzyl, tert-butyl, cyclohexyl, phenyl, methoxy, ethoxy, or phenoxy.

Examples of the complexes containing two K′ groups are compounds corresponding to the formula:

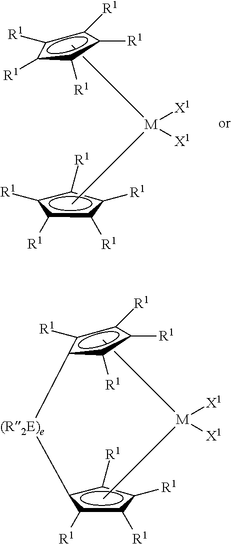

wherein:
M is titanium, zirconium or hafnium, preferably zirconium or hafnium, in the +2 or +4 formal oxidation state;
R¹ in each occurrence independently is selected from the group consisting of hydrogen, hydrocarbyl, halocarbyl, substituted hydrocarbyl, halide, and combinations thereof, said R₁ having up to 20 non-hydrogen atoms, or adjacent R¹ groups together form a divalent derivative (that is, a hydrocarbadiyl, substituted hydrocarbadiyl or halocarbadiyl group) thereby forming a fused ring system, and
X¹ independently each occurrence is an anionic ligand group of up to 20 non-hydrogen atoms, or two X¹ groups together form a divalent anionic ligand group of up to 40 non-hydrogen atoms or together are a conjugated diene having from 4 to 40 non-hydrogen atoms bonded by means of delocalized π-electrons to M, whereupon M is in the +2 formal oxidation state, and
R″, E, and e are as previously defined.

Preferred X¹ groups are selected from halide, hydride, hydrocarbyl, substituted hydrocarbyl, and halocarbyl groups, or two X¹ groups together form a divalent derivative of a conjugated diene or else together they form a neutral, π-bonded, conjugated diene. Most preferred X¹ groups are C₁₋₃₀ hydrocarbyl groups and halides, such as methyl, chloride, bromide, ethyl, and 1,4-diphenyl-1,3-butadiene.

Examples of analyte solutions of metal complexes of the foregoing formula suitable for use in the present invention include:
bis(cyclopentadienyl) zirconium dichloride;
bis(methylcyclopentadienyl)zirconium dichloride;
(2,4,6-trimethylindenyl)(3-methyl-1-n-butylcyclopentadienyl)zirconium dichloride;
bis(indenyl)zirconiumdichloride;
dimethylsilylene-bis(2-methyl-4-bromoindenyl)zirconium dichloride;
dimethylsilylene-bis(2-methyl-4-phenylindenyl)zirconium dichloride;
diethylsilylene-bis(2-methyl-4-phenylindenyl)zirconium dichloride;
dimethylsilylene-bis[2-isopropyl-4-(1,1′-biphen-2-yl)indenyl]zirconium dichloride;
dimethylsilylene-bis[2-methyl-4-(o-tolyl)indenyl]zirconium dichloride;
dimethylsilylene-bis[2-methyl-4-(p-tolyl)indenyl]zirconium dichloride;
dimethylsilylene-bis[2-methyl-4,6-diisopropylindenyl]zirconium dichloride;
dimethylsilylene-bis[2-methyl-4,6-diisopropylindenyl]hafnium dichloride;
dimethylsilylene-bis[2,5-dimethyl-4-(3,5-di-trifluoromethylphen-1-yl)indenyl]zirconium dichloride;
dimethylsilylene-bis[2,6-dimethyl-4-(3,5-di-trifluoromethylphen-1-yl)indenyl]zirconium dichloride;
bis(4,5-dimethyl-cyclopenta[b]thienyl)zirconium dichloride;
bis(5,6-dimethyl-cyclopenta[b]thienyl)zirconium dichloride;
dimethylsilylbis(2-methyl-4-phenylindenyl)zirconium (II) 1,4-diphenyl-1,3-butadiene;
dimethylsilyl(tetramethylcyclopentadienyl) (fluorenyl)zirconium dichloride;
ethylenebis(indenyl)zirconium 1,4-diphenyl-1,3-butadiene;
(isopropylidene)(cyclopentadienyl)(fluorenyl)hafnium dichloride; and the like.

A further class of metal complexes utilized in the present invention corresponds to the formula:

MK′JXₓZ_{z}

or a dimer thereof, wherein M, K′, X, Z, x, and z are as previously defined, and J is a ligand of up to 50 non-hydrogen atoms that is bonded to both K′ and M, forming a metallocycle.

Preferred J ligands include groups containing up to 30 non-hydrogen atoms comprising at least one atom that is oxygen, sulfur, boron or a member of group 14 of the Periodic Table of the Elements directly bonded to K′, and a different atom, selected from the group consisting of nitrogen, phosphorus, oxygen or sulfur that is bonded to M.

More specifically this class of metal complexes used according to the present invention includes mono-cyclopentadienyl heteroatom based metallocenes corresponding to the formula:

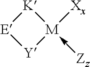

wherein:
M is preferably, titanium, zirconium, or hafnium, more preferably titanium in the +2, +3, or +4 formal oxidation state;
K′ is a delocalized, π-bonded ligand group optionally substituted with from 1 to 5 (typically 1, 2, 3, 4, or 5) R² groups;
R², each independently, is selected from the group consisting of hydrogen, hydrocarbyl, halocarbyl, substituted hydrocarbyl, halide and combinations thereof, said R² having up to 20 non-hydrogen atoms, or adjacent R² groups together form a divalent derivative (that is, a hydrocarbadiyl, substituted hydrocarbadiyl or halocarbadiyl group) thereby forming a fused ring system;
each X is a halide, hydrocarbyl, halocarbyl or substituted hydrocarbyl group, said group having up to 20 non-hydrogen atoms, or two X groups together form a divalent anionic ligand group of up to 40 non-hydrogen atoms or together are a conjugated diene having from 4 to 40 non-hydrogen atoms bonded by means of delocalized π-electrons to M;
x is 1 or 2;
Y′ is —O—, —S—, —NR³—, —PR³—, wherein R³ is selected from the group consisting of hydrogen, hydrocarbyl, substituted hydrocarbyl, halocarbyl, halide, and combinations thereof;
E′ is SiR⁴₂, CR⁴₂, SiR⁴₂SiR⁴₂, CR⁴₂CR⁴₂, CR⁴═CR⁴, CR⁴₂SiR⁴₂, or GeR⁴₂, wherein R⁴ each independently is hydrogen or a group selected from hydrocarbyl, substituted hydrocarbyl, halocarbyl and combinations thereof, said R⁴ having up to 30 non-hydrogen atoms;
Z, each independently, is a neutral, Lewis base donor ligand of up to 50 non-hydrogen atoms containing at least one unshared electron pair through which Z is coordinated to M; and
z is 0 to 3.

Preferred examples of analyte solutions of the foregoing metal complexes include:
dimethylsilylene(2-methyl-4-bromoindenyl)(t-butylamido)titanium dichloride;
dimethylsilylene(2-methyl-4-phenylindenyl)(t-butylamido)titanium dichloride;
diethylsilylene(2-methyl-4-phenylindenyl)(t-butylamido)titanium dichloride;
dimethylsilylene[2-isopropyl-4-(1,1′-biphen-2-yl)indenyl](t-butylamido)zirconium dichloride;
dimethylsilylene[2-methyl-4-(p-tolyl)indenyl](t-butylamido)titanium dichloride;
dimethylsilylene[2-methyl-4-(p-tolyl)indenyl](adamant-1-ylamido)titanium dichloride;
dimethylsilylene[2-methyl-4,6-di-isopropylindenyl](cyclohexylamido)titanium dichloride;
dimethylsilylene(4,5-dimethyl-cyclopenta[b]thienyl)(t-butyl amido)titanium dichloride;
diphenylsilyl(2-methyl-4-phenylindenyl)(t-butylamido)zirconium (II) 1,4-diphenyl-1,3-butadiene;
dimethylsilylene(2-methyl-4-phenylindenyl)(t-butylamido)titanium (II) 1,4-diphenyl-1,3-butadiene;
dimethylsilyl(tetramethylcyclopentadienyl)(t-butylamido)titanium dimethyl;
dimethylsilyl(tetramethylcyclopentadienyl)(adamant-1-ylamido)titanium dimethyl;
dimethylsilyl(tetramethylcyclopentadienyl)(cyclododecylamido)titanium dimethyl;
ethylene(indenyl)(cyclododecylamido)zirconium 1,4-diphenyl-1,3-butadiene; and the like.

Additional information on metallocene compounds useful in the invention is described throughout in, for example, METALLOCENE-BASED POLYOLEFINS, Vol. 1 & 2 (John Scheirs & W. Kaminsky eds., John Wiley & Sons, 2000); G. G. Hlatky in COORDINATION CHEM. REV. Vol. 181, pp. 243-296, 1999 and in particular, for use in the synthesis of polyethylene in METALLOCENE-BASED POLYOLEFINS, Vol. 1, pp. 261-377, 2000.

A further class of metal complexes utilized in the present invention are chelate complexes corresponds to the formula

K″ₖMXₓZ_{z}

wherein:
M, X, and Z are as previously defined;
each K″ is independently a chelating ligand comprising 2, 3, or 4 heteroatoms that are bonded to M;
k is 1 or 2;
c is the absolute value of formal charge on K″ and is 0, 1, 2, 3, or 4;
x is 1, 2, or 3;
z is 0, 1, 2, or 3;
and (k×c)+x is equal to the formal oxidation state of M;
and further optionally one or more K″ groups may be bonded to Z, to X, or to both Z and X.

In some embodiments, the heteroatoms of K″ are preferably selected from N, P, O, and S, with N and O being the most preferred. In some embodiments, K″ additionally comprises a monocyclic or polycyclic arenyl and/or heteroarenyl moiety.

Preferred examples of analyte solutions of the foregoing metal complexes include:
2′,2″-[pentane-2,4-diylbis(oxy)]bis[3-(9H-carbazol-9-yl)-5-methylbiphenyl-2-oxy]hafnium dichloride;
[2′,2″-[1,2-cyclohexanediylbis(methyleneoxy-κO)]bis[3-(9H-carbazol-9-yl)-5-methyl[1,1′-biphenyl]-2-olato-κO]hafnium dichloride;
[2′,2″-[1,4-butanediylbis(oxy-κO)]bis[3-(9H-carbazol-9-yl)-5-methyl[1,1′-biphenyl]-2-olato-κO]hafnium dichloride;
dichlorobis[2-[[4-(dimethylamino)phenyl]imino]-1-(2-naphthalenyl)ethanone]hafnium dichloride;
bis(2-mesitylamidoethyl)methylamine hafnium dimethyl;
N,N′-diisopropyl-2,2-dimethylpropanimidamidyl Zirconium(IV)tribenzyl;
[N-[2,6-bis(1-methylethyl)phenyl]-6-[2-[(phenylamino-κN)methyl]-1-naphthalenyl]-2-pyridinemethanaminato(2-)-κN¹,κN²]zirconium dichloride;
N,N′-bis(3,5-bis(tert-butyl)-2-hydroxyphenylmethyl)-N,N′-dimethylethylenediamine zirconium(IV) dibenzyl;
bis[4-methyl-N,N′-bis(trimethylsilyl)benzenecarboximidamidato-κN,κN′]titanium dichloride;
[N¹-(2,3,4,5,6-pentamethylphenyl)-N²-[2-[(2,3,4,5,6-pentamethylphenyl)amino-κN]ethyl]-1,2-ethanediaminato(2-)-κN¹,κN²]zirconium dimethyl;
[2-[[bis[(2-pyridinyl-κN)methyl]amino-κN]methyl]-4,6-bis(1,1-dimethylethyl)phenolato-κO]zirconium dibenzyl;
[N-[2,6-bis(1-methylethyl)phenyl]-α-[2-(1-methylethyl)phenyl]-6-(1-naphthalenyl-κC2)-2-pyridinemethanaminato(2-)-κN¹,κN²]-dimethylhafnium;
N-bis[bis(2-methoxyphenyl)phosphino]methylamino chromium trichloride;
(N¹,N³-diphenyl-1,3-propanediamido)bis(tetrahydrofurano)zirconium dichloride; and the like.

In some embodiments, the protically unstable compounds comprise a metalloid from groups 13 to 16. In preferred embodiments, the protically unstable compounds comprise at least one of B, Si, Ge, As, Sb, and Te. Useful compounds for analyte solutions include bis(2-methyl-4-bromoindenyl)dimethylsilane, bis(2-methyl-4-chloroindenyl)dimethylgermane, and the like. In some embodiments, protically unstable compounds are organometalloid halides. Organometalloid halides have a bond between the metalloid and the halide. Useful compounds for analyte solutions include (indenyl)dimethyl(chloro)silane, (2-methyl)dimethyl(chloro)germane, (cyclopentadienyl)diphenyl(chloro)silane, and the like.

In some embodiments, the protically unstable compounds comprise a lanthanide metal. In preferred embodiments, the protically unstable compounds comprise at least one of Ce, Pr, Nd, Sm, Gd, Dy, Er, Yb, and Lu. Useful compounds for analyte solutions include neodymium tris(hexamethyldisilazide), bis(cyclopentadienyl)ytterbium chloride, bis(pentamethylcyclopentadienyl)samarium bis(tetrahydrofuran), bis(pentamethylcyclopentadienyl)lutetium hydride, and the like.

In some embodiments, the protically unstable compounds comprise metals from groups 1 and 2. In preferred examples, the organometallic compounds comprise at least one of Li, Na, K, Mg, and Ca. For example, compounds such as ArLi(TMEDA) and ArLi(phenanthroline) are useful in processes herein (where Ar represents a substituted aryl group and TMEDA means tetramethylethylenediamine).

In some embodiments, the protically unstable compounds comprise a compounds of the formula:

R′ₙTₘQX′_{(q-n-2m)}

wherein Q is selected from B, Al, C, Si, Ge, Sn, P, As, Sb, S, Se, and Te;
q represents the formal oxidation state of Q (preferably 2, 3, 4, 5, or 6);
R′ each is independently a hydrocarbyl, substituted hydrocarbyl, or halocarbyl substituent, and is bonded to Q;
n represents the number of R′ substituents, and is an integer greater than zero (preferably n is 1, 2, 3, 4, 5, or 6);
T is a group 16 element, preferably oxygen, and if present, is bonded to Q;
m represents the number of T substituents, and can be zero (preferably m is 0, 1, or 2);
X′ is a halogen, preferably chlorine;
and q−n−2m represents the number of X′.

In some embodiments, R′ is a hydrocarbyl, substituted hydrocarbyl, or halocarbyl substituent that comprises a monocyclic or polycyclic containing arene. Examples of monocyclic arenes include phenyl and substituted phenyl such as tolyl, mesityl, ethylphenyl, propylphenyl, dimethylphenyl, dipropylphenyl, benzyl, phenethyl, and the like. Examples of polycyclic arenes include substituted or unsubstituted naphthyl, aceanthryl, acenaphthyl, acephenanthryl, anthracenyl, azulenyl, biphenyl, biphenylenyl, chrysenyl, fluoranthenyl, fluorenyl, heptalenyl, as-indacenyl, s-indacenyl, indenyl, pentalenyl, phenalenyl, phenanthrenyl, and the like.

In some embodiments, R′ is a substituted hydrocarbyl substituent that comprises one or more heterocyclic substituents. Examples include substituted and unsubstituted benzofuranyl, carbazolyl, β-carbolinyl, chromenyl, cinnolinyl, furanyl, imidazolyl, indazolyl, indolyl, indolizinyl, isobenzofuranyl, isochromenyl, isoindolyl, isophosphindolyl, isophosphinolinyl, isoquinolinyl, isothiazolyl, isoxazolyl, oxazolyl, phenanthridinyl, phenazinyl, phosphindolyl, pyranyl, pyrazinyl, pyrazolyl, pyridazinyl, pyridinyl, pyrindinyl, pyrimidinyl, pyrrolyl, quinazolinyl, quinolinyl, quinoxalinyl, selenophenyl, thiazolyl, thiophenyl, bipyridinyl, and the like.

Examples of metal complexes of the foregoing formula suitable for use in the present invention as analyte solutions include: dichloro(phenyl)phosphine, chloro(diphenyl)phosphine, benzenesulfonyl chloride, 4-methylbenzene-1-sulfonyl chloride, 2,4,6-triisopropylbenzene-1-sulfonyl chloride, 2-bromobenzoyl chloride, 4-tert-butylbenzoyl chloride, chlorodimethyl(2-methyl-1H-inden-7-yl)silane, and the like. In yet other embodiments of this invention, the protically unstable compounds comprise at least one bond selected from B—Cl, Al—Cl, C—Cl, Si—Cl, Ge—Cl, Sn—Cl, P—Cl, As—Cl, Sb—Cl, S—Cl, Se—Cl, and Te—Cl. Useful compounds for analyte solutions include PhPCl₂, Ph₂PCl (where Ph is phenyl), toluenesulfonyl chloride, 2,4,6-triisopropylphenylsulfonyl chloride, 4-tert-butylbenzoyl chloride, 2-bromobenzoyl chloride, (2-methyl-4-bromoindene-1-yl)dimethyl(chloro)silane, and the like, and mixtures thereof.

In other embodiments, the analyte solution comprises protically stable compounds. For example, compounds comprising one or more transition metals from groups 3 to 6 (preferably groups 3 to 5, preferably group 4). In preferred embodiments, the protically stable compounds comprise at least one transition metal selected from the group consisting of Sc, Y, Ti, Zr, Hf, V, Nb, Ta, and Cr (preferably Sc, Y, Ti, Zr, Hf, V, Nb, and Ta; more preferably Ti, Zr, and Hf).

In particular embodiments, the analyte solution preferably comprises at least one metallocene (including mono-cyclopentadienyl transition metal complexes, preferably hafnocenes, zirconocenes, and titanocenes), diastereomers of transition metal complexes (preferably rac- and meso-diastereomers), metal complexes, chelate complexes of transition metals, and organometalloid halides. Preferably the analyte solution comprises monocyclic or polycyclic arenyl or heteroarenyl ligands.

Any techniques commonly used in the art to prepare HPLC samples are useful in the present invention. The analyte is typically dissolved in the eluent to be used as the liquid phase to an appropriate concentration. However, another appropriate solvent may be used if necessary. The analyte solution should be of an appropriate concentration to avoid overloading of the column. Overloading of the column may change the peak shapes and prevent adequate separation of the components of the sample solution. The concentration of the solution loaded into the chromatographic system is typically in the range of from about 0.5 to 5 mg/ml, from about 0.5 to 3 mg/ml, or from about 1 to 2 mg/ml. Alternatively, the concentration of the sample (such as transition metal complex compounds) loaded into the chromatographic system may be expressed in terms of grams of the sample loaded per cm² of the cross-sectional area of the stationary phase (or column). In such cases, the concentration of the sample loaded is preferably in the range of from about 10⁻² to 10⁻⁶ gcm⁻², from 10⁻³ to 10⁻⁵ gcm⁻², or from about 10⁻⁴ to 10⁻⁵ gcm⁻².

This solution of the sample may be filtered or centrifuged before injection to remove any undissolved material. Any filtration or centrifugation method known in the art may be used. A 0.45 micron disposable filter is used in the Examples below.

After the sample is dissolved in an appropriate solvent to an appropriate concentration, the sample solution is then loaded into the chromatographic system. The sample solution may be loaded into the chromatographic system using any technique known in the art. Typically, the sample solution is injected into the chromatographic system.

In embodiments herein, the injection temperature may be in the range of from about 0° C. to about 200° C., from about 5° C. to about 150° C., from about 10° C. to about 80° C., from about 20° C. to about 80° C., from about 25° C. to about 50° C., from about 25° C. to about 35° C., and about 25° C. (or ambient temperature) being most preferred.

### The Chromatographic System

The chromatographic system comprises a liquid phase flowing through a solid stationary phase. The chromatographic system may further comprise other components such as a high performance liquid chromatography pump and a detector. Other components may include solvent reservoirs and processing and display units. Each of these components is discussed further below. The chromatographic system may be coupled, on line, or off line with other analytical methods. For example, the effluent from a size exclusion chromatography column can be analyzed by the method of this invention to determine the purity of the various fraction and/or the purity of the desired product fractions.

### The Solid Stationary Phase

The “stationary phase” is the chromatographically retentive immobile phase involved in the chromatographic process. The stationary phase in liquid chromatography can be a solid, a bonded, an immobilized or a coated phase on a solid support or a wall-coated phase. The stationary phase often characterizes the liquid chromatography mode. For example, silica gel is typically used in adsorption chromatography and octadecylsilane bonded phase is generally used in reversed-phase chromatography.

In the present invention, the solid stationary phase comprises graphitic carbon. “Graphitic carbon”, also known as “graphitized carbon”, is used herein to mean any materials comprising the element carbon in the allotropic form of graphite, irrespective of structural defects, as long as the three-dimensional hexagonal crystalline long range order can be detected by diffraction methods such as X-ray diffraction spectroscopy independent of the volume fraction and homogeneity of the distribution of such crystalline domains. Porous graphitic carbon, carbon nanotubes and fullerenes (such as carbon buckyballs) are examples of forms of graphitic carbon that are useful herein. Preferably, the solid stationary phase consists essentially of graphitic carbon, preferably porous graphitic carbon.

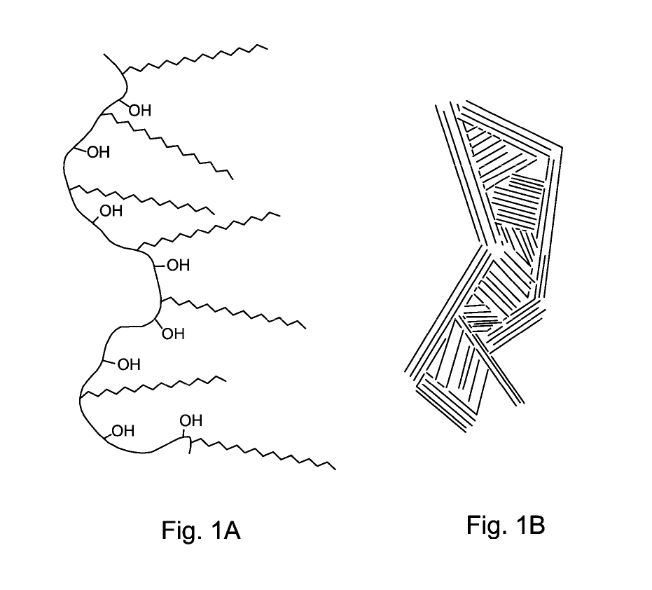

The graphitic carbon is usually packed into columns, and is typically comprised at the molecular level of flat sheets of hexagonally arranged carbon atoms. These carbon atoms preferably have a fully satisfied valence. This is in direct contrast to traditional reversed phase HPLC stationary phases such as C₁₈ modified silica (octadecylsilane). These surfaces are depicted in FIG. 1. FIG. 1-A represents the surface of a C₁₈ modified silica which has both C₁₈ molecules and hydroxyl groups available at the surface. The hydroxyl groups may react with or degrade samples comprising certain metal compounds. Indeed, the surface of the C₁₈ modified silica stationary phase provides a protic environment, which may encourage the decomposition of protically unstable compounds. In contrast, FIG. 1-B represents the surface of graphitic carbon sheets in a surface architecture that is regular and two-dimensional. This surface comprises flat sheets of hexagonally arranged carbon atoms showing sp2 hybridization. Within the sheets, the carbon atoms are preferably valence satisfied and the surface is typically homogenous. Accordingly, the surface of the graphitic carbon lacks groups having acidic protons, for example hydroxyl groups. This provides an aprotic environment. The inventors surmise that the flat layered surface characteristics and the zero protic activity of the graphitic carbon may advantageously allow separation of hydrolytically unstable compounds.

Without wishing to be bound by theory, the inventors speculate that the retention mechanism on the graphite column is most likely explained by the interaction between the planar carbon surface of the graphite and molecules of analyte, possibly involving some π-π (pi-pi) interactions between the aromatic system of graphite and the one in the analyte (if it is aromatic or has double or triple bonds). The difference in bonding energy is thought to be largely dependent on the ability of the molecule to “fit” the sites in the graphite surface that allow separation of, for example, structurally related but geometrically different mixtures such as mixtures of rac- and meso-diastereomers, mixtures of diastereomeric chelate complexes, and mixtures of diastereomeric “open” metallocenes. It is worth noting that common reversed phase columns would not show such separation even if the hydrolytic stability of the compounds were not an issue.

In some embodiments, the graphitic carbon preferably has one or more of the following properties: (i) is non-protic; (ii) is hydrophobic; (iii) comprises particles having a diameter in the range of about 1 to about 10 micrometers (preferably 3 to 7, preferably 3 to 5, preferably 3, 5, or 7 micrometers); (iv) is stable across a pH range of from about 1 to about 14; (v) has a pore size of from about 200 to about 300 Angstrom (preferably 230 to 270, preferably about 250 Angstroms); and (vi) has a specific surface area of about 100 to about 140 m²/g (preferably 110 to 130, preferably 120 m²/g).

In other embodiments, the graphitic carbon can withstand pressures of at least 400 bar (40 MPa). The chemical properties of the graphitic carbon are different from that of conventional solid stationary phase materials typically used in HPLC. For example, the graphitic carbon is stable over the entire pH range of 0 to 14. This is in contrast to silica based stationary phases, including octadecylsilane, which typically restrict the choice of mobile phases to those having a pH within the range of 2 to 8, due to the limited stability of the bulk silica particles. For example, at low pH, cleavage of the organosilane groups on the C₁₈ modified silica may occur. Accordingly, use of graphitic carbon as the stationary phase advantageously does not restrict the choice of mobile solvents due to pH considerations.

Any column comprising graphitic carbon may be used in the present invention. The length of the column is typically from about 30 mm to about 100 mm, and can have a diameter of from about 2 mm to about 5 mm. Examples of commercially available graphitic carbon columns include Hypercarb® columns (available from Thermo Electron Company, Bellefonte, Pa.), TSK-gel Carbon-500® column (commercially available from Tosoh, Tokyo, Japan), Zircarb® column (commercially available from ZirChrom Separations, Inc., Anoka, Minn.), BTR Carbon® or Carbonex columns (commercially available from BioTech Research, Kawagoe, Japan) or other custom made columns prepared from graphitic carbon or other solids included graphitic carbon as a column packaging material.

The temperature of the graphitic column may be in the range of from about 0° C. to about 200° C., from about 5° C. to about 150° C., from about 10° C. to about 80° C., from about 20° C. to about 80° C., from about 25° C. to about 50° C., from about 25° C. to about 35° C., and about 25° C. (or ambient temperature) being most preferred during the methods herein. Additionally, methods of the present invention may include a temperature gradient to facilitate fractionation.

### The Liquid Phase

In methods of the present invention, the “liquid phase” is the mobile phase used to perform the separation, and may also be referred to as the eluent. Preferably, the liquid phase comprises one or more of tetrahydrofuran, diethyl ether, methyl tert-butyl ether, dioxane, di-n-butyl ether, 1,2-dimethoxyethane, diphenyl ether, diethyleneglycol dimethyl ether, triethylamine, diethylamine, n-butylamine, benzylamine, aniline, nitromethane, nitrobenzene, N-methylpyrrolidone, anisole, methylene chloride, chloroform, carbon tetrachloride, 1,2-dichloroethane, 1,2-dibromoethane, tert-butyl chloride, isopropyl chloride, trichlorofluoromethane, benzotrifluoride, fluorobenzene, chlorobenzene, bromobenzene, perfluorodecane, hexafluorobenzene, 1,2-dichlorobenzene, pentane, hexanes, heptane, n-octane, cyclohexane, methylcyclohexane, petroleum ether, benzene, toluene, xylene, ethyl acetate, acetone, dimethylsulfoxide, dimethylformamide, acetonitrile, perfluorohexane, and mixtures thereof. More preferably, the liquid phase comprises one or more of tetrahydrofuran, methylene chloride, chloroform, toluene, hexanes, heptanes, 1,1-dichloroethane, o-dichlorobenzene, perfluorohexane, and mixtures thereof. In some embodiments, a solvent gradient may be used. In other embodiments, both a solvent and a temperature gradient may be used.

Preferably, the liquid phase is anhydrous. The liquid phase may be dried using any technique known in the art. Preferably, the liquid phase is dried using 4 Angstrom molecular sieves. Preferably, the dried liquid phase has 30 ppm of water or less (preferably 25 ppm or less, preferably 15 ppm or less, most preferably 5 ppm or less).

In embodiments herein, the preferred flow rate is any flow rate that provides substantial resolution of the analyte peaks. “Resolution” (Rs) refers to the degree of separateness of two analytes on a chromatogram. For example, for two peaks A and B on a chromatogram, Rs=2(t_{RA}−t_{RB})/(W_{A}+W_{B}), where t_{RA} and t_{RB} are the retention times for peaks A and B, respectively, and W_{A} and W_{B} are the widths of peaks A and B, respectively, where the widths are measured at the baseline. “Substantially resolved,” as used herein, means a resolution of greater than 1.0 (preferably greater than 1.5).

For preparative HPLC, the flow rate of the liquid phase is in the range of from about 0.1 to about 1000 ml/min, from about 0.1 to about 250 ml/min, from about 1.0 to about 150 ml/min, from about 5 to about 125 ml/min, or from about 10 to about 100 ml/min. In other embodiments, such as for determining purity, the flow rate is preferably in the range of from about 0.1 to about 50 ml/min, preferably from about 20 to about 50 ml/min, more preferably from about 30 to about 45 ml/min) Alternatively, the flow rate is about 0.60 to 60 ml min⁻¹ cm⁻², preferably about 3 to 30 ml min⁻¹ cm⁻², or preferably about 6 to 18 ml min⁻¹ cm⁻².

### Other Components

Other components of the chromatographic system may include a high performance liquid chromatography pump, a detector, solvent reservoirs, injector or autosampler, fraction collector or other suitable sample management system, valves, and processing and display units. It is within the scope of this invention that other HPLC column may be coupled, on or offline, with the chromatographic system described herein. For example, a gel permeation chromatography column may be added to remove impurities, such as polymeric impurities.

An HPLC pump is used to provide high pressure for the movement of the liquid phase through the column. Any suitable pump or pump system may be used. For example, a Waters 600 LCD HPLC pump (commercially available from Waters Corporation, Milford, Mass.) may be used.

The detector detects the passage of the components of the sample (or analyte) through the column. Any suitable detector may be used. UV-vis detectors and V is detectors may also be useful in chromatographic systems of the present invention. For example, a photodiode array detector (PDA) may of particular use. A PDA is linear array of discrete photodiodes on an integrated chip. For HPLC detection, it is placed in the image plane of a spectrophotometer to allow a range of wavelengths to be detected simultaneously, thereby allowing trace impurity detection, and accurate quantitation. Single or multiple wave detectors and spectrophotometers may also be useful herein. Mass-selective detectors, for example single or multiple quadrupole detectors or ion traps, may be useful in some embodiments. In other embodiments, useful detectors include evaporative light scattering detector, refractive index detector, fluorescence detector, infrared detector, or combinations of any of the above.

The output from the detector is typically in the form of a chromatogram. A “chromatogram” is a plot of detector signal output or analyte concentration versus time or elution volume during the chromatographic process. In some embodiments, the output will be recorded as a series of peaks, each representing a compound in the analyte passing through the detector and absorbing UV and/or vis light. The time taken for a particular compound to travel through the column to the detector is known as its retention time. This time is measured from the time the analyte is injected into the chromatographic system to the point where the display shows a maximum peak height for that compound. Different compounds have different retention times. For a particular compound the retention time may depend on the pressure used (or the flow rate of the liquid phase), the nature of the stationary phase, the composition of the liquid phase, and the temperature of the column. For each compound, the area under each peak is proportional to the amount of that compound that has passed through the detector.

In embodiments of this invention, the retention factor is greater than 0. “Retention factor” means the period of time that the analyte component resides in the stationary phase relative to the time it resides in the mobile phase. Retention factor (k) is calculated from the adjusted retention time divided by the holdup time; k=(t_{R}−tₘ)/tₘ, where t_{R} is retention time for the sample peak and t_{M} is the retention time for an unretained peak. When an analyte's retention factor is less than one, elution is typically so fast that accurate determination of the retention time is very difficult. Accordingly, because embodiments herein have a retention factor greater than 0, retention times of the analyte may be accurately determined Indeed, the retention factor is preferably greater than 1. Retention factors greater than 20 mean that elution takes a very long time. In embodiments herein, the retention factor is less than 20 (preferably less than 15, preferably less than 10, preferably less than 5, and preferably from 1 to 20, preferably from 1 to 5).

The methods of the present invention may find tremendous utility in the purification of metal compounds, particularly protically unstable compounds. Additionally the methods of the present invention may be used to evaluate the purity of a sample comprising metal compounds, particularly protically unstable compounds. These methods provide an advantage over conventional HPLC methods due to the ability to separate protically unstable compounds without decomposition. These methods provide another advantage over conventional HPLC columns by allowing the separation of metal compounds that could not be substantially resolved on conventional HPLC columns. These inventive methods provide yet another advantage in that separations can be carried out when both mobile and stationary phases are non-polar.

The invention, accordingly, provides the following embodiments:

1. A method for chromatography comprising:
(a) introducing an analyte solution (preferably at a concentration of 0.5 to 5 mg/ml, from about 0.5 to 3 mg/ml, or from about 1 to 2 mg/ml, alternately in the range of from about 10⁻² to 10⁻⁶ gcm⁻², from 10⁻³ to 10⁻⁵ gcm⁻², or from about 10⁻⁴ to 10⁻⁵ gcm⁻²; preferably at an injection temperature in the range of from about 0° C. to about 200° C., from about 5° C. to about 150° C., from about 10° C. to about 80° C., from about 20° C. to about 80° C., from about 25° C. to about 50° C., from about 25° C. to about 35° C., and about 25° C. being most preferred) comprising protically unstable compounds (comprising a transition metal from groups 3 to 12 (preferably a transition metal from groups 3 to 6, preferably a transition metal from groups 3 to 5) and/or a lanthanide metal (preferably selected from Ce, Pr, Nd, Sm, Gd, Dy, Er, Yb, and Lu) a metalloid from groups 13 to 16 (preferably at least one of B, Si, Ge, As, Sb, and Te, preferably an organometalloid halide) and/or a metal from groups 1 and 2 (preferably selected from Li, Na, K, Mg, and Ca)) into a chromatographic system comprising a liquid phase (preferably comprising comprises one or more of tetrahydrofuran, diethyl ether, methyl tert-butyl ether, dioxane, di-n-butyl ether, 1,2-dimethoxyethane, diphenyl ether, diethyleneglycol dimethyl ether, triethylamine, diethylamine, n-butylamine, benzylamine, aniline, nitromethane, nitrobenzene, N-methylpyrrolidone, anisole, methylene chloride, chloroform, carbon tetrachloride, 1,2-dichloroethane, 1,2-dibromoethane, tert-butyl chloride, isopropyl chloride, trichlorofluoromethane, benzotrifluoride, fluorobenzene, chlorobenzene, bromobenzene, perfluorodecane, hexafluorobenzene, 1,2-dichlorobenzene, pentane, hexanes, heptane, n-octane, cyclohexane, methylcyclohexane, petroleum ether, benzene, toluene, xylene, ethyl acetate, acetone, dimethylsulfoxide, dimethylformamide, acetonitrile, and mixtures thereof; more preferably tetrahydrofuran, methylene chloride, chloroform, toluene, hexanes, heptanes, 1,1-dichloroethane, o-dichlorobenzene and mixtures thereof) flowing through a solid stationary phase, wherein the solid stationary phase comprises graphitic carbon (preferably porous graphitic carbon, carbon nanotubes, or carbon buckyballs, most preferably porous graphitic carbon) and has one or more of the following properties: (i) is non-protic; (ii) is hydrophobic; (iii) comprises particles having a diameter in the range of about 1 to about 10 micrometers (preferably 3 to 7, preferably 3 to 5, preferably 3, 5, or 7 micrometers); (iv) is stable across a pH range of from about 1 to about 14; (v) has a pore size of about from about 200 to about 300 Angstrom (preferably 230 to 270, preferably about 250 Angstroms); and (vi) has a specific surface area of about 100 to about 140 m²/g (preferably 110 to 130, preferably 120 m²/g); and
(b) eluting compounds from the stationary phase with a retention factor greater than zero (preferably less than 20, preferably less than 15, preferably less than 10, preferably less than 5, preferably from 1 to 20, and preferably from 1 to 5), wherein a chromatogram shows that the eluted compounds are substantially resolved (preferably the eluted compounds have a resolution of greater than 1.0, preferably greater than 1.5).
2. The method of paragraph 1, wherein the analyte solution comprises isomers of organometallic compounds (preferably rac- and meso-isomers), metallocenes, diastereomers of chelate complexes of transition metals, or organometalloid halides.
3. A method for chromatography comprising:
(a) introducing an analyte solution comprising compounds comprising a transition metal compounds from groups 3 to 6 (preferably Sc, Y, La, Ti, Zr, Hf, V, Nb, Ta, and Cr; preferably groups 3 to 5; preferably Sc, Y, La, Ti, Zr, Hf, V, Nb, and Ta; preferably at least one of metallocenes, chelate complexes of transition metals, or organometalloid halides) into a chromatographic system comprising a liquid phase (preferably comprises one or more of tetrahydrofuran, diethyl ether, methyl tert-butyl ether, dioxane, di-n-butyl ether, 1,2-dimethoxyethane, diphenyl ether, diethyleneglycol dimethyl ether, triethylamine, diethylamine, n-butylamine, benzylamine, aniline, nitromethane, nitrobenzene, N-methylpyrrolidone, anisole, methylene chloride, chloroform, carbon tetrachloride, 1,2-dichloroethane, 1,2-dibromoethane, tert-butyl chloride, isopropyl chloride, trichlorofluoromethane, benzotrifluoride, fluorobenzene, chlorobenzene, bromobenzene, perfluorodecane, hexafluorobenzene, 1,2-dichlorobenzene, pentane, hexanes, heptane, n-octane, cyclohexane, methylcyclohexane, petroleum ether, benzene, toluene, xylene, ethyl acetate, acetone, dimethylsulfoxide, dimethylformamide, acetonitrile, and mixtures thereof) flowing through a solid stationary phase, wherein the solid stationary phase comprises graphitic carbon (preferably porous graphitic carbon, carbon nanotubes, or fullerenes (such as carbon buckyballs), most preferably porous graphitic carbon) and preferably has one or more of the following properties: (i) is non-protic; (ii) is hydrophobic; (iii) comprises particles having a diameter in the range of about 1 to about 10 micrometers (preferably 3 to 7, preferably 3 to 5, preferably 3, 5, or 7 micrometers); (iv) is stable across a pH range of from about 1 to about 14; (v) has a pore size of about from about 200 to about 300 Angstrom (preferably 230 to 270, preferably about 250 Angstroms); and (vi) has a specific surface area of about 100 to about 140 m²/g (preferably 110 to 130, preferably 120 m²/g); and
(b) eluting compounds from the stationary phase with a retention factor greater than zero (preferably less than 20, preferably less than 15, preferably less than 10, preferably less than 5, preferably from 1 to 20, and preferably from 1 to 5), wherein a chromatogram shows that the eluted compounds are substantially resolved (preferably the eluted compounds have a resolution of greater than 1.0, preferably greater than 1.5).
4. The method of paragraphs 1 to 3, wherein the liquid phase is anhydrous (preferably the liquid phase comprises less than 30 ppm of water, preferably 25 ppm or less; preferably 15 ppm or less; most preferably 5 ppm or less).
5. The method of paragraphs 1 to 4, wherein the chromatographic system further comprises a high performance liquid chromatography pump and a detector (preferably one or more of UV-vis detectors and V is detectors (such as a photodiode array detector); single or multiple wave detectors, spectrophotometers, mass-selective detectors (for example single or multiple quadrupole detectors or ion traps), evaporative light scattering detectors, refractive index detectors, fluorescence detectors, infrared detectors, or combinations of any of the above).
6. A method for determining the purity of an analyte solution comprising the methods of paragraphs 1 to 5, and further comprising: (c) determining the amount of the desired compound.

### EXAMPLES

The use of high performance liquid chromatography (HPLC) for analysis and separation of metal and/or metalloid containing complexes and/or other protically unstable compounds, and in particular group 4 metallocenes, including ansa-complexes, is shown in the Examples below.

### Chromatographic System

A chromatographic system was assembled for separation of transition metal complexes and other protically unstable complexes. The chromatographic system comprised a Waters 600 LCD HPLC pump (Waters Corporation, Milford, Mass.), a Waters 996 photodiode array (PDA) detector, and a 150×4.6 mm Hypercarb™ column (Thermo Electron Company, Bellafonte, Pa.).

### Eluents

The eluents were placed into bottles that were connected to a high pressure nitrogen or helium cylinder using perfluoroalkyl (PFA) tubing. Nitrogen gas containing <5 ppm of oxygen and water was used for Examples 1 to 16. The pressure of nitrogen was set to about 8 psi, thereby preventing the contact of the eluents with air. Helium was used for the remaining examples. The column was at ambient temperature.

Hexanes and tetrahydrofuran (THF) were chosen as solvents having lower and higher elution strength, respectively. THF was distilled over sodium benzophenone ketyl, and hexanes were distilled over n-BuLi with phenanthroline as the indicator and used in Examples 1 through 5. For Examples 6 through 29, all eluents were dried over 4 Angstrom molecular sieves.

### Sample Preparation

The samples were dissolved in anhydrous THF at concentrations of 1 mg/ml, and the obtained solutions were injected via a 20 μl loop at ambient temperature. In most cases, the flow was set to 1 or 2 ml/min. The flow rate is reported below for each Example.

### Chromatography Results

For all Figures, at the top-left is the contour plot of the three-dimensional surface of absorbance as a function of elution time and wavelength; the bottom-left plot of the figure corresponds to a wavelength slice (indicated by the black, horizontal line in the contour plot), and it is the elution time vs. absorbance (AU) at a fixed wavelength; the right-side plot of the figure corresponds to a time slice (indicated by the colored vertical lines in the contour plot), and it is the wavelength (nm) vs. absorbance in the same color as the time slice (in some figures multiple colors/time slices are plotted).

### Examples 1 to 5

### Graphitic Column; Eluents Dried Via Distillation

### Example 1

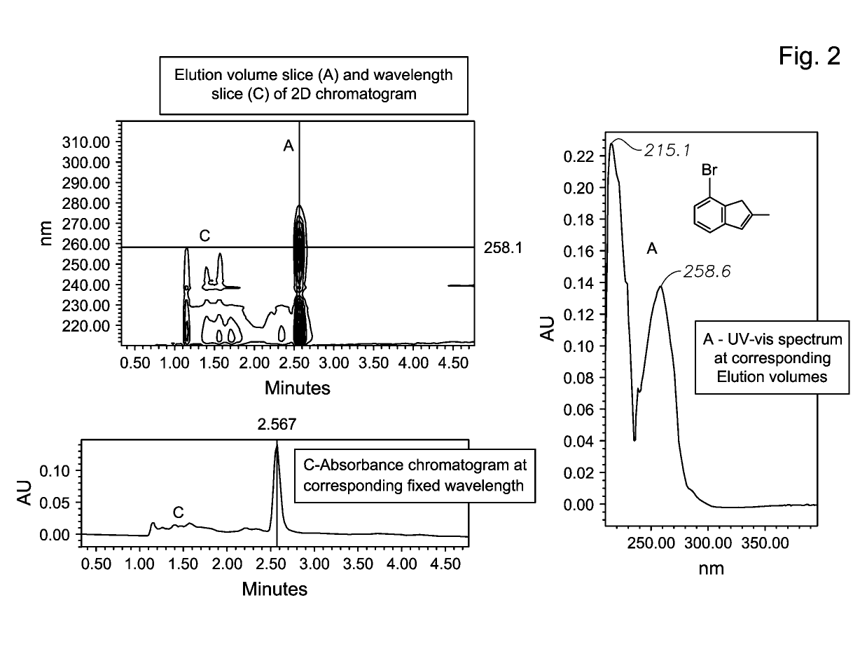

2-methyl-7-bromoindene was eluted using the chromatographic system disclosed herein, using THF as the eluent, at a flow rate of 2 ml/min. The chromatogram of 2-methyl-7-bromoindene is shown in FIG. 2. No decomposition was observed.

### Example 2

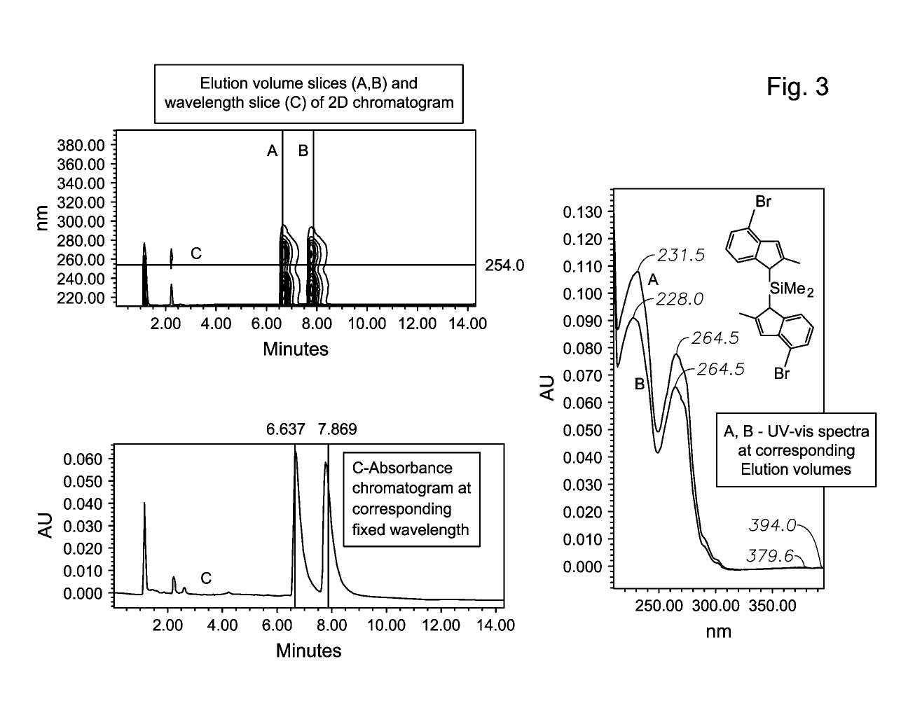

A mixture comprising the rac- and meso-isomers of bis (2-methyl-4-bromoindenyl)dimethylsilane was separated as shown in FIG. 3. THF was used as the eluent at a flow rate of 2 ml/min.

### Example 3

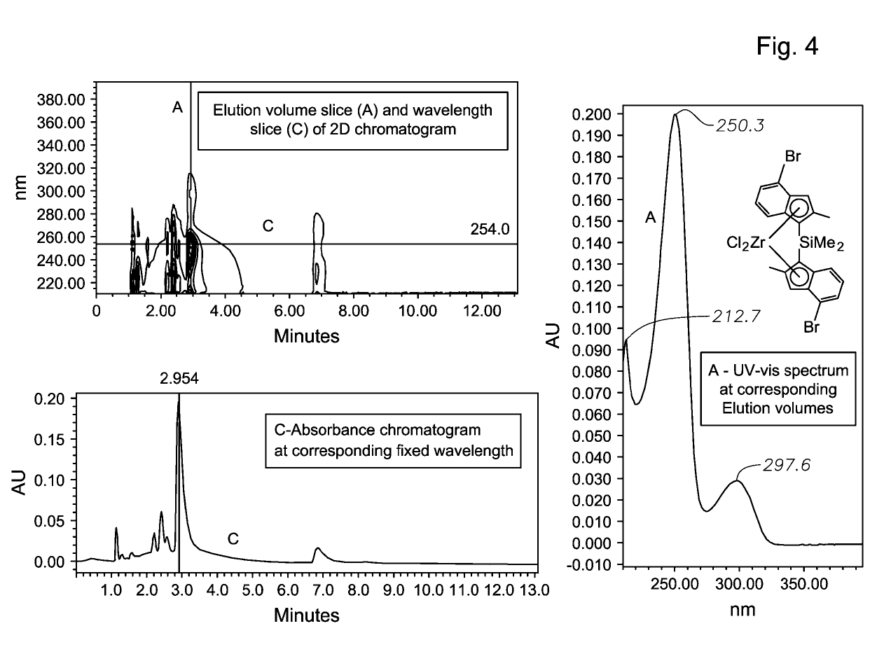

A solution of the respective racemic ansa-zirconocene dichloride, i.e. dimethylsilylenebis(2-methyl-4-bromoindenyl)zirconium dichloride was injected into the chromatographic system. THF was used as the eluent at a flow rate of 2 ml/min. However, the chromatogram only showed peaks that can be attributed to decomposition products (see FIG. 4).

### Example 4

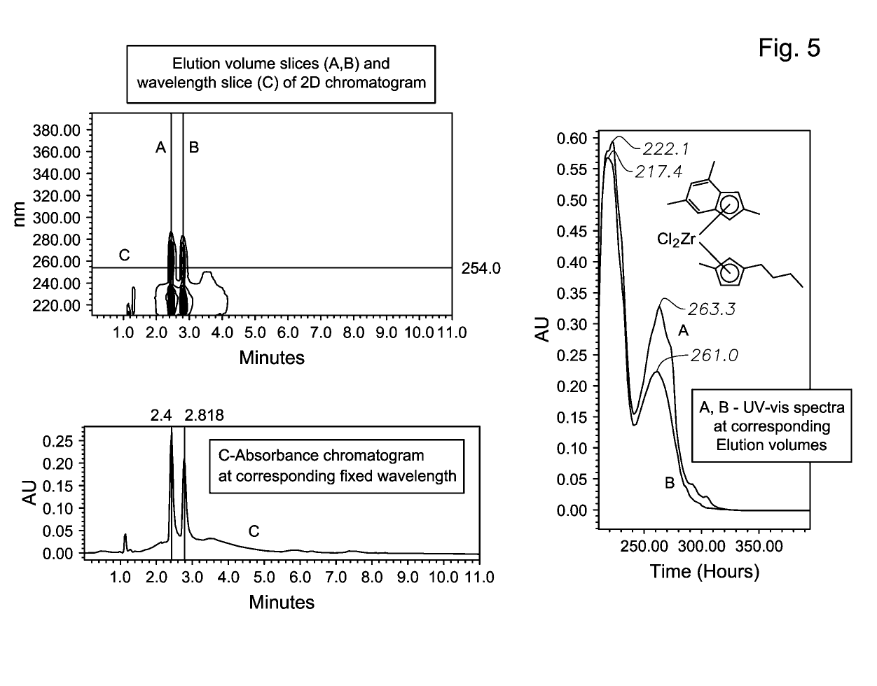

A mixture comprising the rac- and meso-isomers of (2,4,6-trimethylindenyl)(3-methyl-1-n-butylcyclopentadienyl) zirconium dichloride was injected into the chromatographic system. THF was used as the eluent at a flow rate of 2 ml/min. FIG. 5 shows that two diastereomeric complexes that differ in the mutual orientation of the cyclopentadienyl and indenyl rings are clearly separated by the column, though some signs of decomposition are observed.

### Example 5

A mixture comprising the rac-dimethylsilylene-bis-[1,1′-biphenyl]-2-yl)-2-isopropylindenyl)zirconium dichloride and about 5% of the meso-isomer was injected into the chromatographic system. THF was used as the eluent at a flow rate of 1 ml/min. Clear separation of the diastereomers was seen. The retention time of each diastereomer is reported for Example 5 in Table 1, below.

### Examples 6-14

### Graphitic Column; Eluents Dried Over 4 Angstrom Molecular Sieves

### Example 6

Rac-diethylsilylene-bis(2-methyl-4-bromoindenyl)zirconium dichloride was eluted using THF, at a flow rate of 1 ml/min. However, the peak shape was asymmetrical and quite far from ideal (6A). Use of dichloromethane as an eluent at a flow rate of 1 ml/min somewhat reduces peak width of the peaks while leaving them still unsymmetrical (6B). However, use of a 1:1, by volume, mixture of CH₂Cl₂ and toluene (toluene is one of the strongest eluents for this type of column) at a flow rate of 1 ml/min results in almost ideal symmetrical peaks in the chromatogram (6C). Clear separation was seen. The retention times for the rac-isomer are reported for Examples 6A, 6B, and 6C in Table 1, below.

However, a mixture of rac- and meso-complexes of diethylsilylene-bis(2-methyl-4-bromoindenyl)zirconium dichloride formed during epimerization of pure racemate is separated better in pure CH₂Cl₂ (6E) than in a 1:1 (by volume) CH₂Cl₂-toluene mixture (6D). Clear separation of the diastereomers was seen. The retention times for each isomer are reported for Examples 6D and 6E in Table 1, below.

### Example 7

A mixture of rac- and meso-dimethylsilylene-bis(2-methyl-4-phenylindenyl)zirconium dichloride was found to require more than 60 ml of dichloromethane for complete elution of rac- and meso-zirconocenes from a 150×4.6 mm Hypercarb™ column. The flow rate was 4 ml/min. Clear separation of the diastereomers was seen (7A).

Use of a stronger eluent, for example, a mixture of toluene and CH₂Cl₂ (1:1 by volume) at a flow rate of 2 ml/min, reduces the retention times, but also results in a merger of the peaks attributed to rac- and meso-complexes (7B).

However, rac- and meso-complexes are completely resolved in pure toluene (flow rate of 1 ml/min). It should be noted that order of the peaks attributed to rac- and meso-complexes is changed by replacing pure dichloromethane with pure toluene (7C). The retention times for each diastereomer are reported for Examples 7A, 7B, and 7C in Table 1, below.

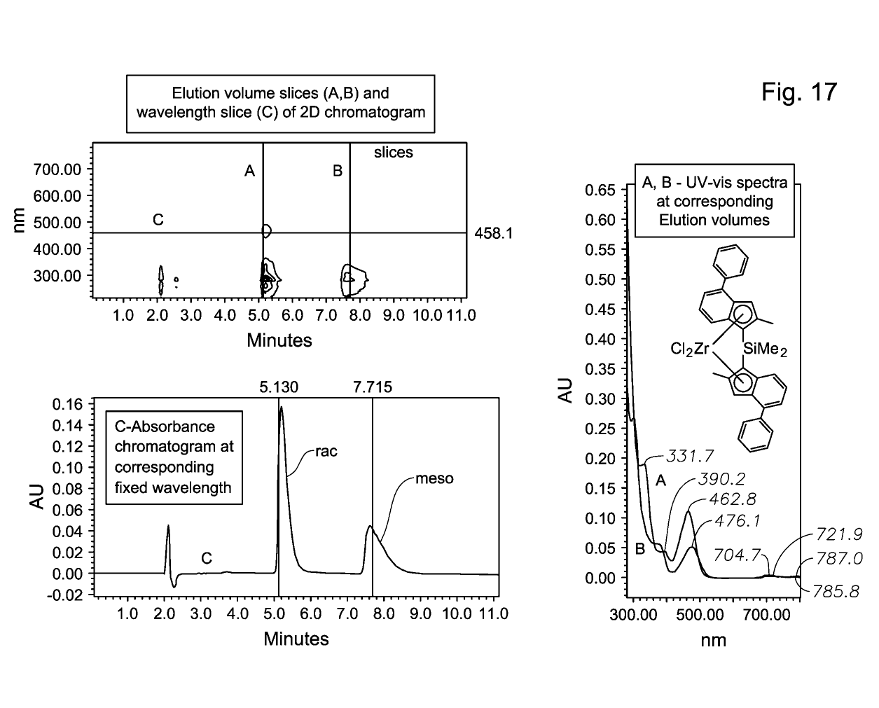

The rac- and meso-complexes are also completely resolved in pure benzene (flow rate of 1 ml/min), as shown in FIG. 17.

### Example 8

A mixture of rac- and meso-dimethylsilylene-bis(2-methyl-4-o-tolylindenyl)zirconium dichloride bearing o-tolyl in position 4 of the indenyl group exhibits complete resolution in toluene at a flow rate of 1 ml/min. The retention times for each diastereomer are reported as Example 8 in Table 1, below.

### Example 9

A mixture of rac- and meso-dimethylsilyene-bis(2,5-dimethyl-4-phenylindenyl)zirconium dichloride was separated using different eluents as described below. In dichloromethane, at a flow rate of 1 to 4 ml/min (average flow rate was about 2 ml/min), the diastereomeric complexes were retained by the graphite surface, resulting in longer retention times (9A).

The order of the peaks attributed to the diastereomeric complexes remains unchanged when pure toluene was used as an eluent (flow rate of 1 ml/min) (9B).

Gradient elution (from a 1:1 mixture of THF and toluene to pure toluene for 10 min, at a flow rate of 1 ml/min) was used for better resolution of the peaks (9C). The peak square ratio measured at 470.5 nm shows good reproducibility irrespective of the eluent applied. The retention times for each diastereomer are reported as Examples 9A, 9B, and 9C in Table 1, below.

### Example 10

A clear separation of a mixture of rac- and meso-dimethylsilylene-bis(2-methyl-4,6-diisopropylindenyl)hafnium dichloride was achieved using CH₂Cl₂ as an eluent at a flow rate of 1 ml/min. The retention times for each diastereomer are reported as Example 10 in Table 1, below.

### Example 11

A clear separation of a mixture of rac- and meso-dimethylsilylene-bis(2,5-dimethyl-4-[3,5-di(trifluoromethylphenyl)indenyl]zirconium dichloride was obtained using a 1:1 (by volume) mixture of toluene/CH₂Cl₂ at a flow rate of 1 ml/min. The retention times for each diastereomer are reported as Example 11 in Table 1, below.

### Example 12

A clear separation of a mixture of rac- and meso-dimethylsilylene-bis(2,6-dimethyl-4-[3,5-di(trifluoromethylphenyl]indenyl)zirconium dichloride was achieved using toluene as the eluent at a flow rate of 2 ml/min. The retention times for each diastereomer are reported as Example 12 in Table 1, below.

### Example 13

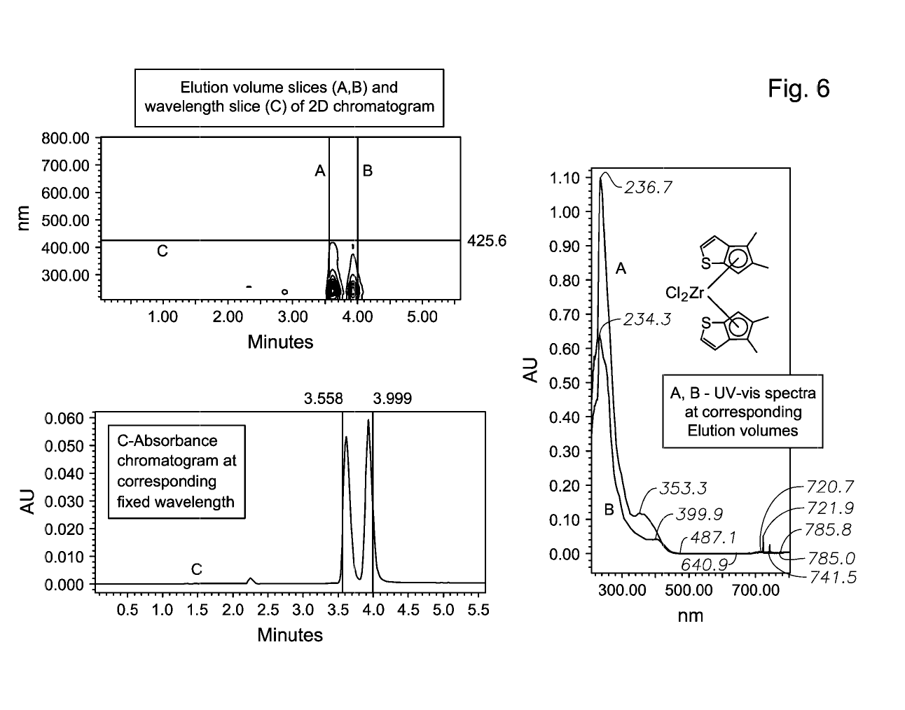

FIG. 6 shows the clear separation of a mixture of rac- and meso-bis(4,5-dimethylcyclopenta[b]thienyl)zirconium dichloride using CH₂Cl₂ as the eluent at a flow rate of 1 ml/min.

### Example 14

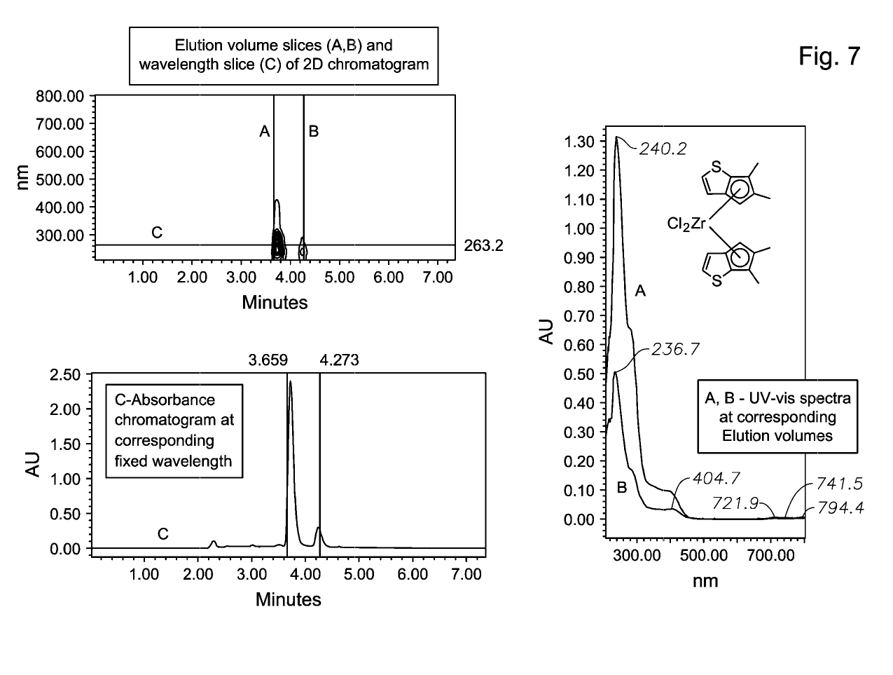

FIG. 7 shows the clear separation of a mixture of rac- and meso-bis(5,6-dimethylcyclopenta[b]thienyl)zirconium dichloride using CH₂Cl₂ as the eluent at a flow rate of 1 ml/min.

### Examples 15 to 17

### Comparative Examples; Eluents Dried Over 4 Angstrom Molecular Sieves

The following four alternative analytical HPLC columns were tested: HAMILTON PRP-1 (Hamilton Company, Reno, Nev.) (300×4.6, polystyrene, the other carbon-based phase bearing phenyl (Ph) groups, but including no silanol groups), MONOCHROM 5u CN, commercially available from Agilent Technologies, Santa Clara, Calif. (150×3.1, cyanopropyl-bonded silica), WATERS XBridge Phenyl (150×4.6, phenylalkyl groups bonded on silica surface; this column is known to have good selectivity for separation of polyaromatic compounds), and THERMO Fluorophase PFP (150×2.1, ω-C₆F₅-alkyl groups bonded with silica; this column provides good selectivity for chlorine- and fluorine-containing compounds). Three different eluents (hexanes, THF and dichloromethane) were studied. Some retention was observed in hexanes only.

### Comparative Example 15

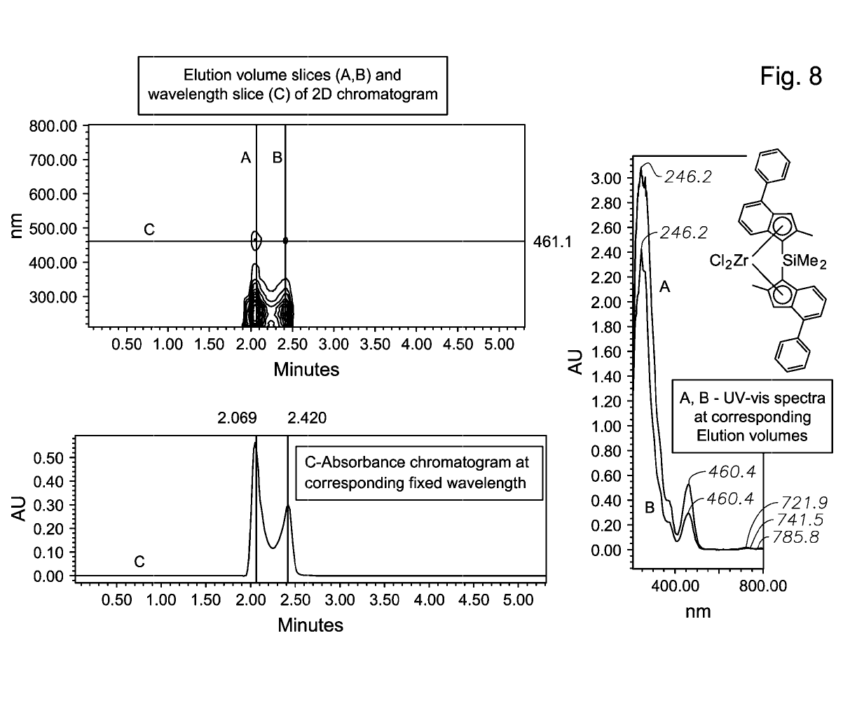

FIG. 8 shows the separation of a 1:1 mixture of rac- and meso-dimethylsilylene-bis(2-methyl-4-phenylindenyl)zirconium dichloride using a WATERS XBridge Phenyl column and an eluent of hexanes at a flow rate of 1 ml/min. Most of the injected complex is not retained by the column, while the part retained shows very low retention time and no selectivity, so rac- and meso-isomers are not adequately separated.

### Comparative Example 16

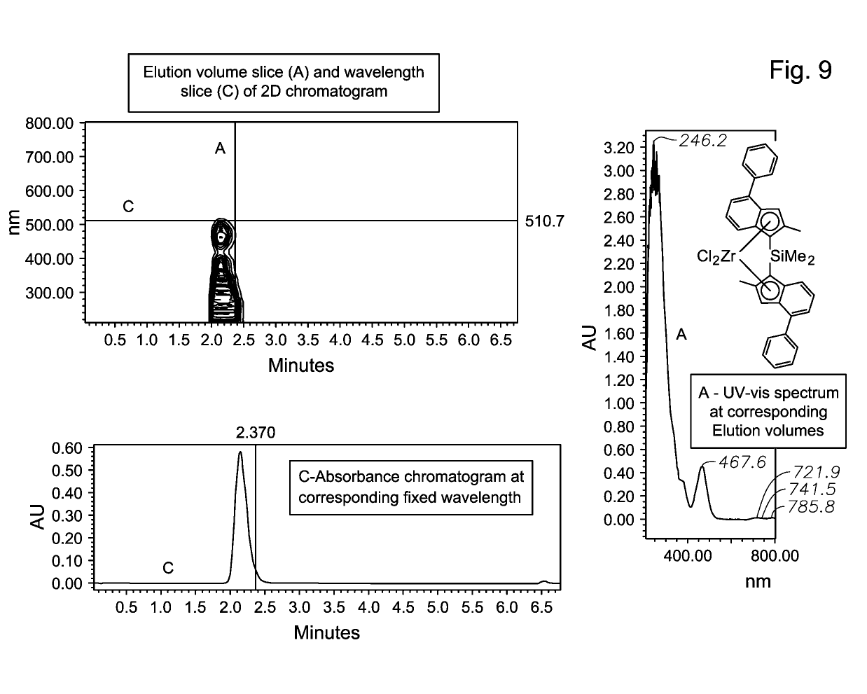

FIG. 9 shows the separation of a 1:1 mixture of rac- and meso-dimethylsilylene-bis(2-methyl-4-phenylindenyl)zirconium dichloride using a THERMO Fluorophase PFP column and an eluent of THF at a flow rate of 1 ml/min. Here, the rac- and meso-isomers are not separated at all.

Comparative Examples 15 and 16 show chromatograms typical for silica-based columns. The rac-/meso-mixture is not retained despite the eluent choice, though there are no signs of possible decomposition by the residual silanol groups.

### Comparative Example 17

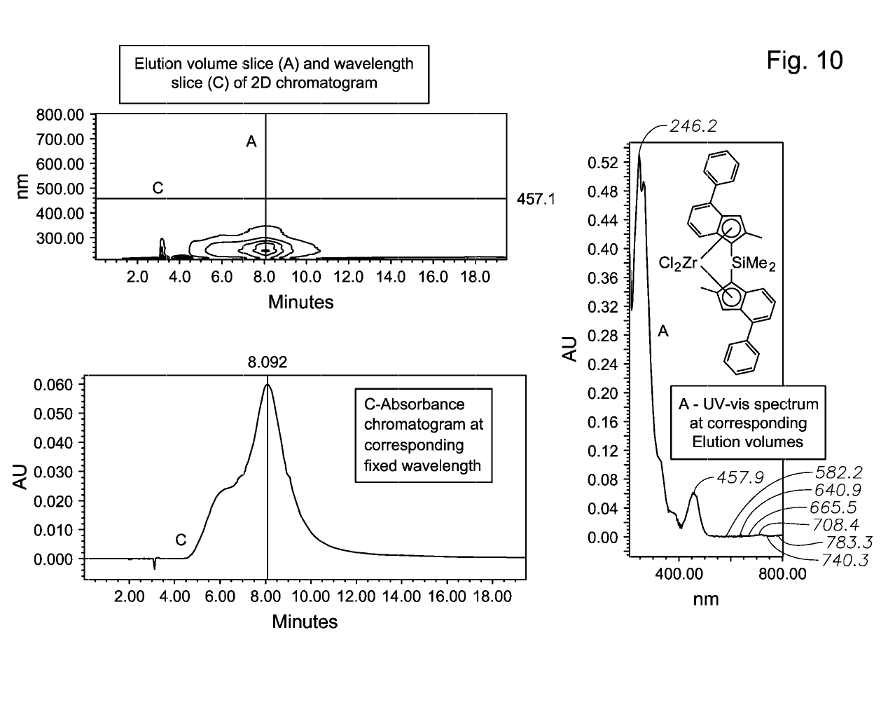

FIG. 10 shows the separation of a 1:1 mixture of rac- and meso-dimethylsilylene-bis(2-methyl-4-phenylindenyl)zirconium dichloride using a polystyrene column (HAMILTON PRP-1) and an eluent of hexanes at a flow rate of 1 ml/min. The polystyrene column showed some retention of the studied zirconium complexes, but also unsatisfactory blurred peak shape and no selectivity was observed. In CH₂Cl₂ and THF, the results obtained on polystyrene-based column are similar to those obtained on silica-based columns, that is, no decomposition, but also no retention and therefore no separation of the complexes were observed.

For the silica and polystyrene based columns, even hexanes was found to be a too strong eluent.

### Examples 18-29

### Graphitic Column; Eluents Dried Over 4 A Molecular Sieves

### Example 18

A clear separation of a 1:1 mixture of rac- and meso-dimethylsilylene-bis(2-methyl-4-phenylindenyl)zirconium dichloride was achieved using an eluent of benzene at a flow rate of 1 ml/min. The retention times for each diastereomer are reported as Example 18 in Table 1, below.

TABLE 1
Retention Times Of Mixtures of Compounds

| | | | | Retention Time | |
|---|---|---|---|---|---|
| | | | | (minutes) | |
| | | | | Rac | Meso |
| Ex. | Compound Name | Compound Structure¹ | Eluent | isomer | isomer |
| 5 | rac-dimethylsilylene- bis(4-([1,1′-biphenyl]-2-yl)-2- isopropylindenyl) zirconium dichloride, includes 5% of meso-isomer | 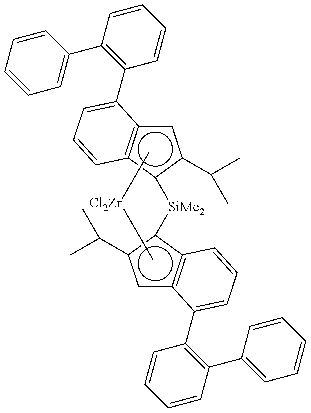 | THF, 1 ml/min | 3.75 | 3.99 |
| 6A | rac-diethylsilylene-bis(2- methyl-4-bromoindenyl) zirconium dichloride | 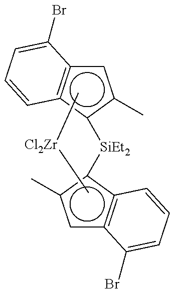 | THF, 1 ml/min | 12.8 | — |
| 6B | rac-diethylsilylene-bis(2-methyl-4- bromoindenyl) zirconium dichloride | 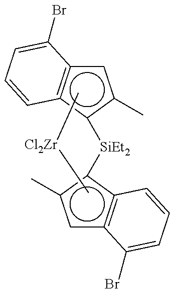 | CH₂Cl₂, 1 ml/min | 13.2 | — |
| 6C | rac-diethylsilylene-bis(2-methyl-4- bromoindenyl) zirconium dichloride | 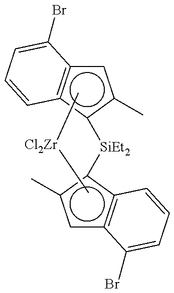 | CH₂Cl₂/ toluene, 1:1, vol., 1 ml/min | 4.28 | — |
| 6D | A mixture of rac- and meso- diethylsilylene-bis(2-methyl-4- bromoindenyl)zirconium dichloride | 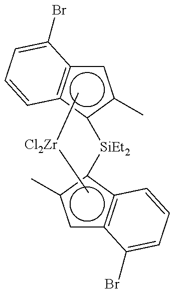 | CH₂Cl₂/ toluene, 1:1, vol., 1 ml/min | 3.87 | 3.75 |
| 6E | A mixture of rac- and meso- diethylsilylene-bis(2-methyl-4- bromoindenyl)zirconium dichloride | 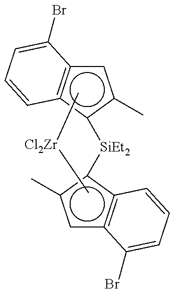 | CH₂Cl₂, 1 ml/min | 15.0 | 12.5 |
| 7A | A mixture of rac- and meso- dimethylsilylene-bis(2-methyl-4- phenylindenyl)zirconium dichloride | 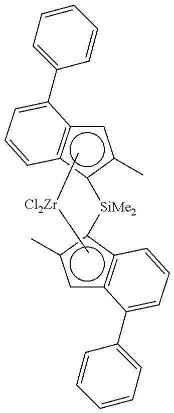 | CH₂Cl₂, 4 ml/min | 16.0 | 13.2 |
| 7B | A mixture of rac- and meso- dimethylsilylene-bis(2-methyl-4- phenylindenyl)zirconium dichloride | 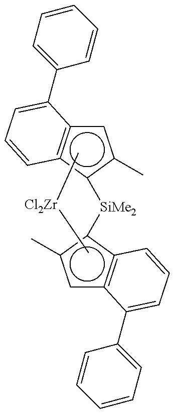 | CH₂Cl₂/ toluene, 1:1, vol., 2 ml/min | 4.15 | 4.02 |
| 7C | A mixture of rac- and meso- dimethylsilylene-bis(2-methyl-4- phenylindenyl)zirconium dichloride | 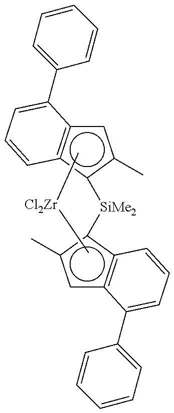 | toluene, 1 ml/min | 3.71 | 4.21 |
| 8 | A mixture of rac- and meso- dimethylsilylene-bis(2-methyl-4-o- tolyllindenyl)zirconium dichloride | 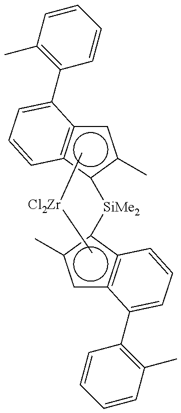 | toluene, 1 ml/min | 2.36 | 3.50 |
| 9A | A mixture of rac- and meso- dimethylsilylene- bis(2,5-dimethyl-4- phenylindenyl)zirconium dichloride | 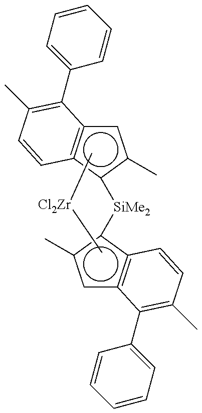 | CH₂Cl₂, 1 to 4 ml/min, average flow was ca. 2 ml/min | 22.6 | 19.7 |
| 9B | A mixture of rac- and meso- dimethylsilylene- bis(2,5-dimethyl-4- phenylindenyl)zirconium dichloride | 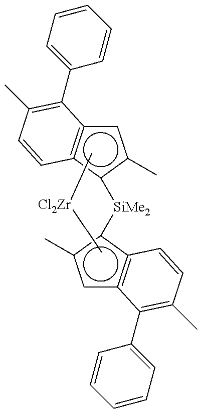 | toluene, 1 ml/min | 3.28 | 3.12 |
| 9C | A mixture of rac- and meso- dimethylsilylene- bis(2,5-dimethyl-4- phenylindenyl)zirconium dichloride | 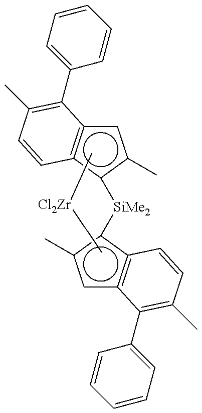 | gradient elution, toluene/ THF, 1:1, vol., to pure toluene in 10 min, 1 ml/min | 5.88 | 4.86 |
| 10 | A mixture of rac- and meso- dimethylsilylene- bis(2-methyl-4,6- diisopropylindenyl)hafnium dichloride | 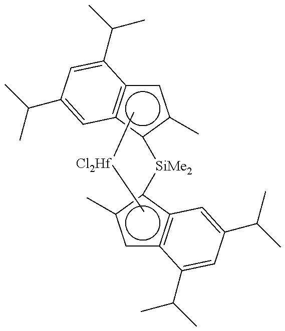 | CH₂Cl₂, 1 ml/min | 3.70 | 2.94 |
| 11 | A mixture of rac- and meso- dimethylsilylene- bis(2,5-dimethyl-4-[3,5- di(trifluoromethyl)phenyl)indenyl] zirconium dichloride | 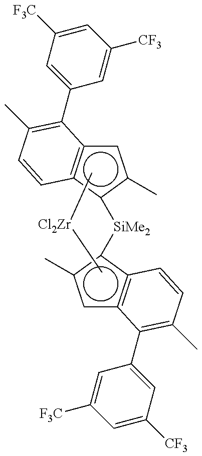 | CH₂Cl₂/ toluene, 1:1, vol., 1 ml/min | 8.52 | 7.56 |
| 12 | A mixture of rac- and meso- dimethylsilylene- bis(2,6-dimethyl-4-[3,5- di(trifluoromethylphenyl]indenyl) zirconium dichloride | 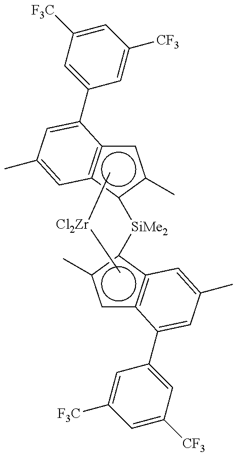 | toluene, 2 ml/min | 3.15 | 1.86 |
| 18 | A mixture of rac- and meso- dimethylsilylene-bis(2-methyl-4- phenylindenyl)zirconium dichloride | 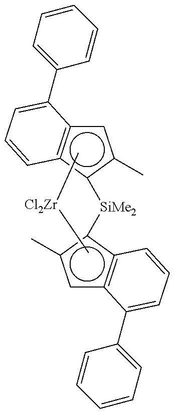 | benzene, 1 ml/min | 7.62 | 5.20 |

¹The compound structures illustrate only one isomer.

### Example 19

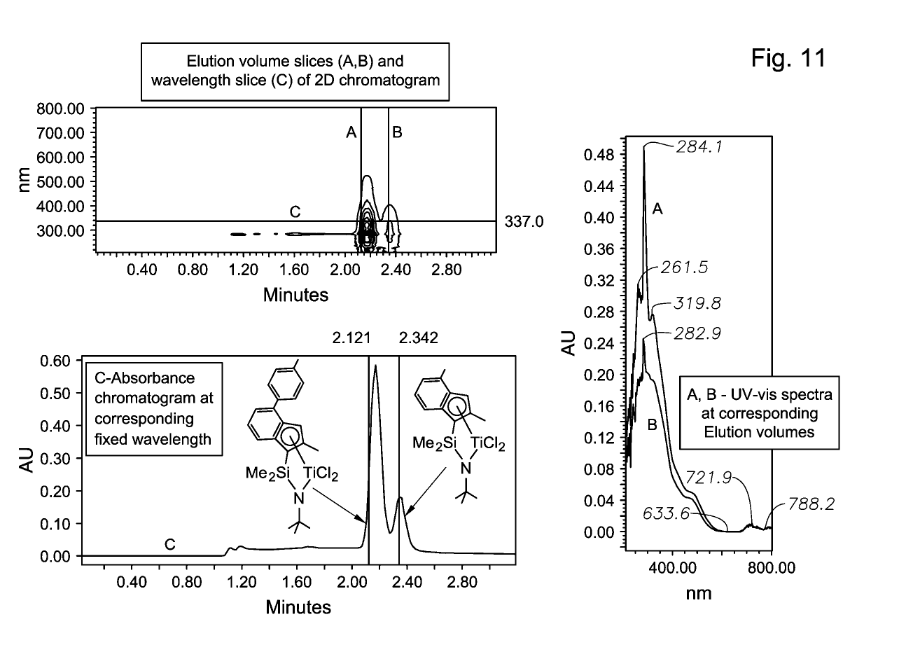

A clear separation of a 1:1 mixture of [N-(tert-butyl)-1,1-dimethylsilanaminato-(2,4-dimethylinden-1-yl)] titanium dichloride and [N-(tert-butyl)-1,1-dimethylsilanaminato-(2-methyl-4-(p-tolyl)inden-1-yl)] titanium dichloride was achieved using an eluent of a 1:1 ratio, by volume, of CH₂Cl₂/toluene at a flow rate of 2 ml/min. The chromatogram is presented as FIG. 11.

### Example 20

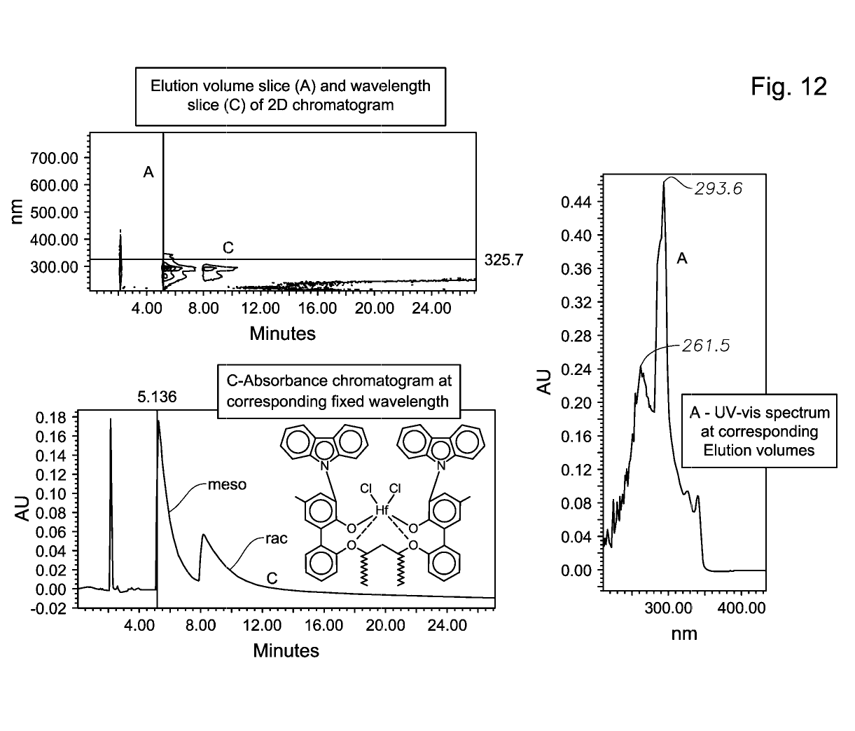

A clear separation of a mixture of 2′,2″-[pentane-2,4-diylbis(oxy)]bis[3-(9H-carbazol-9-yl)-5-methylbiphenyl-2-oxy]hafnium dichloride was achieved using an eluent of toluene at a flow rate of 1 ml/min. The UV-spectra of the diastereomers are identical, so the rac/meso ratio was determined by ¹H NMR to be 1:2. The chromatogram is presented as FIG. 12.

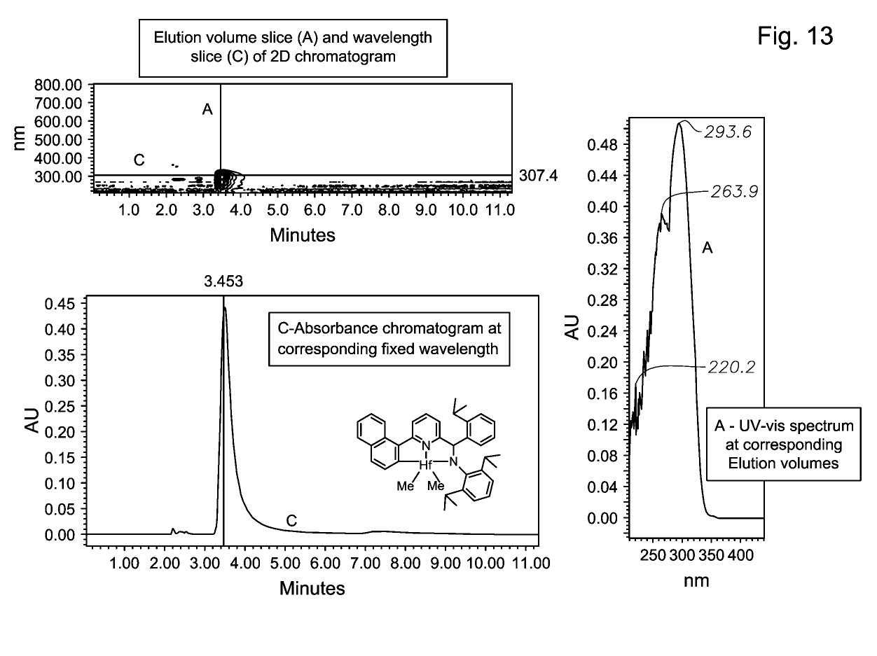

### Example 21

[N-[2,6-bis(1-methylethyl)phenyl]-α-[2-(1-methylethyl)phenyl]-6-(1-naphthalenyl-κC2)-2-pyridinemethanaminato (2-)-κN1,κN2]-dimethylhafnium was eluted using hexane/toluene (1:1 ratio, by volume) at a flow rate of 1 ml/min. No decomposition is observed. The chromatogram is presented as FIG. 13.

### Example 22

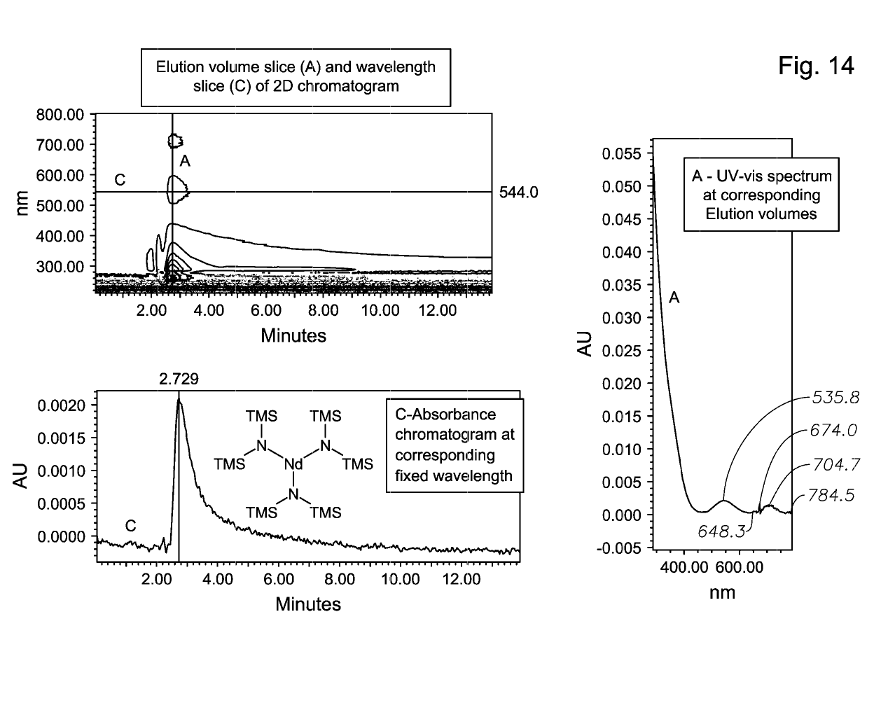

Neodymium tris(hexamethyldisilazide) was eluted using toluene at a flow rate of 1 ml/min. No decomposition is observed. The chromatogram is presented as FIG. 14.

### Example 23

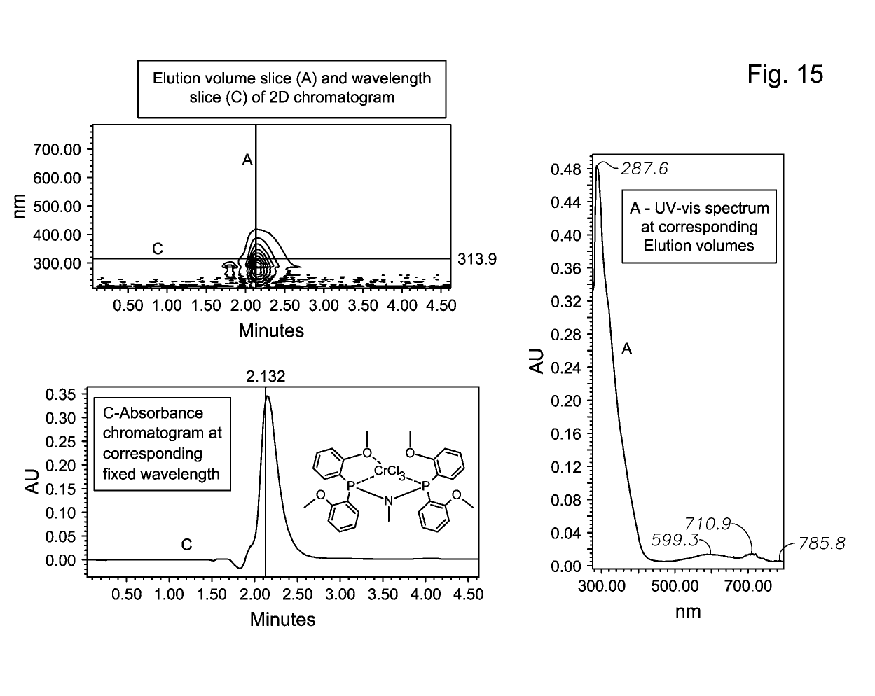

N-bis[bis(2-methoxyphenyl)phosphino]methylamino chromium trichloride was eluted using toluene at a flow rate of 1 ml/min. No decomposition is observed. The chromatogram is presented as FIG. 15.

### Example 24

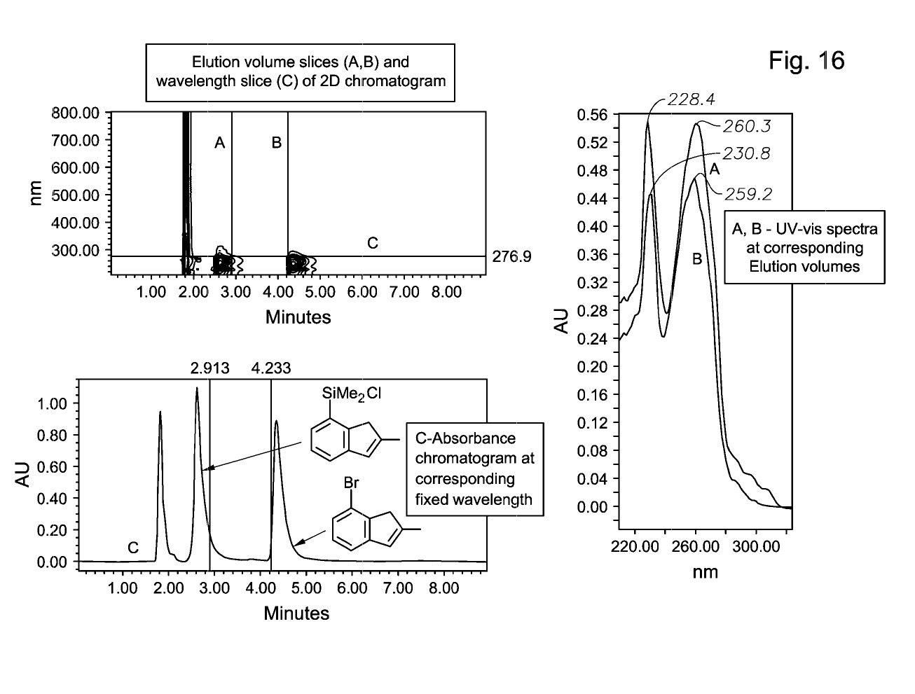

A clear separation of a mixture of 2-methyl-4-bromoindene and (2-methylindene-7-yl)dimethyl-chlorosilane was achieved using an eluent of hexanes/CH₂Cl₂ (1:1, by volume) at a flow rate of 1.5 ml/min. The chromatogram is presented as FIG. 16.

### Example 25

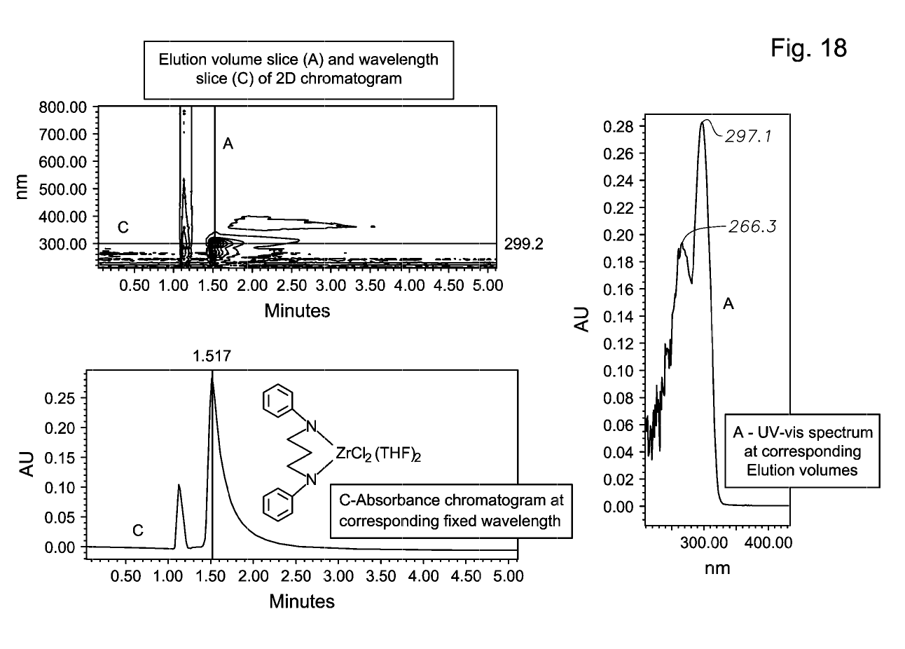

A clear separation of a mixture of (N¹,N³-diphenyl-1,3-propanediamido)bis(tetrahydrofurano)zirconium dichloride was achieved using an eluent of CH₂Cl₂/toluene (1:1, by volume) at a flow rate of 2 ml/min. The chromatogram is presented as FIG. 18.

### Example 26

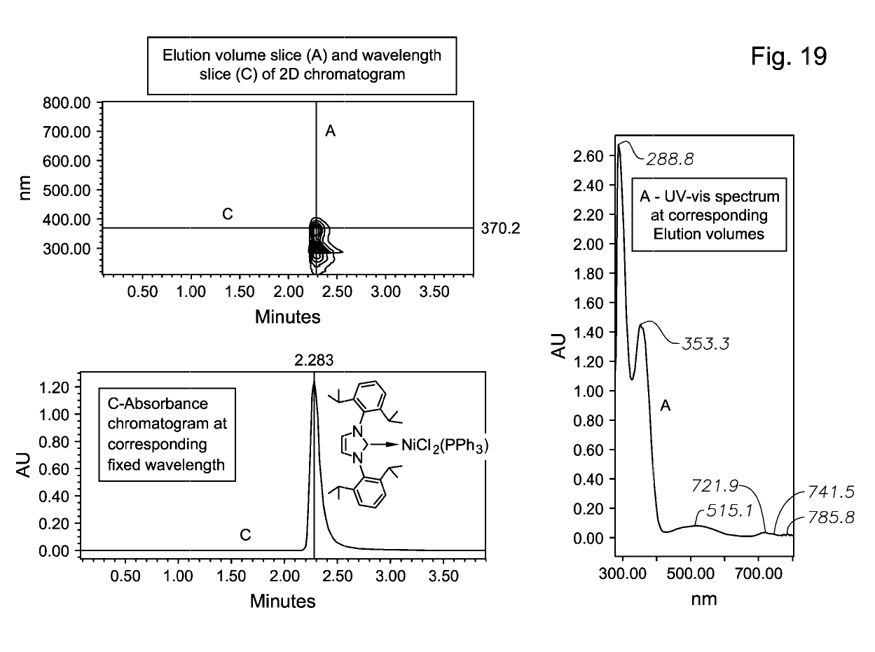

(1,3-bis (2,6-diisopropylphenyl)imidazol-2-ylidene)(triphenylphoshino)nickel dichloride was eluted using toluene at a flow rate of 1 ml/min. The chromatogram is presented as FIG. 19. No decomposition is observed.

### Example 27

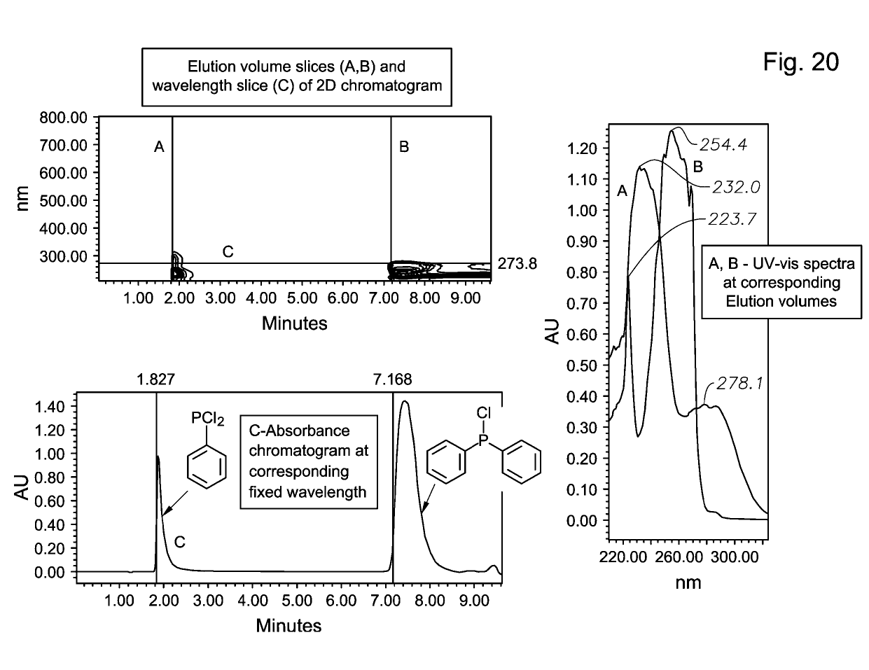

A clear separation of a mixture of mixture of PhPCl₂ and Ph₂PCl (where Ph is phenyl) was achieved using an eluent of hexane at a flow rate of 2 ml/min, then CH₂Cl₂, at a flow rate of 2 ml/min. The chromatogram is presented as FIG. 20.

### Example 28

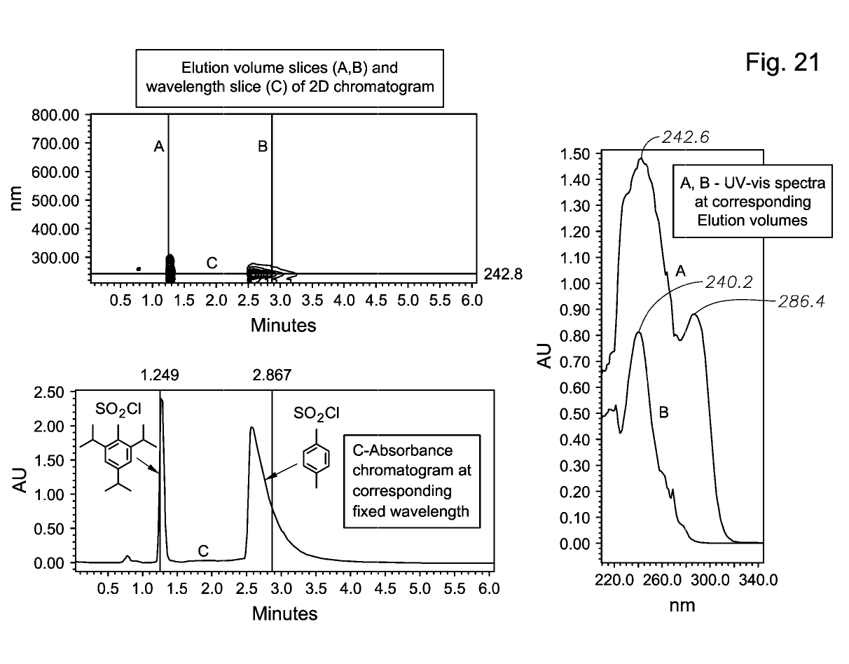

A clear separation of a mixture of mixture of toluenesulfonyl chloride and 2,4,6-triisopropylphenylsulfonyl chloride was achieved using an eluent of hexane at a flow rate of 2 ml/min. The chromatogram is presented as FIG. 21.

### Example 29

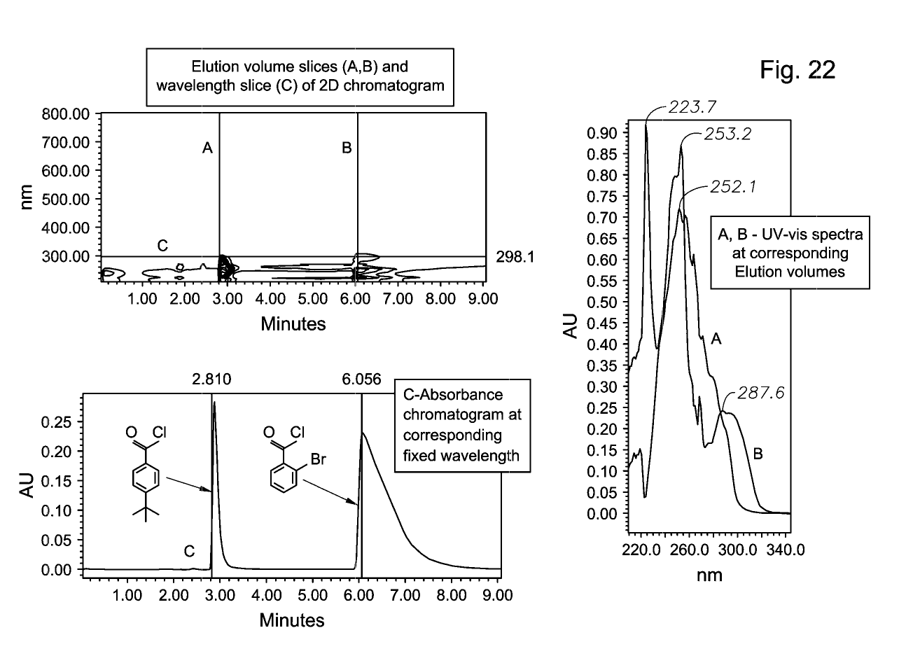

A clear separation of a mixture of mixture of 4-tert-butylbenzoyl chloride and 2-bromobenzoyl chloride was achieved using an eluent of hexane at a flow rate of 1 ml/min. The chromatogram is presented as FIG. 22.

The above described results lead to a conclusion that porous graphitic carbon is an unique stationary phase for the purposes of analysis and separation, not only due to the total absence of the residual surface silanol groups that may potentially react with hydrolytically unstable compounds, but also to the unique retention mechanism allowing separations to be carried out when both mobile and stationary phases are non-polar.

All documents described herein are incorporated by reference herein, including any priority documents and/or testing procedures to the extent they are not inconsistent with this text, provided however that any priority document not named in the initially filed application or filing documents is NOT incorporated by reference herein. As is apparent from the foregoing general description and the specific embodiments, while forms of the invention have been illustrated and described, various modifications can be made without departing from the spirit and scope of the invention. Accordingly, it is not intended that the invention be limited thereby. Likewise, the term “comprising” is considered synonymous with the term “including” for purposes of Australian law. Likewise, “comprising” encompasses the terms “consisting essentially of,” “is,” and “consisting of” and anyplace “comprising” is used “consisting essentially of,” “is,” or “consisting of” may be substituted therefor.

What is claimed is:

1. A method for chromatography comprising:
introducing an analyte solution comprising protically unstable compounds into a chromatographic system comprising a liquid phase flowing through a solid stationary phase, wherein the solid stationary phase comprises graphitic carbon; and
eluting compounds from the stationary phase with a retention factor greater than zero, wherein a chromatogram of the eluted compounds shows that the compounds are substantially resolved.

2. The method of claim 1, wherein the compounds comprise a transition metal from groups 3 to 12, and/or a metalloid from groups 13 to 16, and/or a lanthanide metal, and/or a metal from groups 1 and 2.

3. The method of claim 1, wherein the compounds comprise a transition metal from groups 3 to 6.

4. The method of claim 1, wherein the compounds comprise at least one of Li, Na, K, Mg, Ca, Sc, Y, La, Ti, Zr, Hf, V, Nb, Ta, Cr, Nd, B, Si, Ge, As, Sb, Te, Ce, Pr, Nd, Sm, Gd, Dy, Er, Yb, and Lu.

5. The method of claim 1, wherein the compounds of the analyte solution comprise diastereomers.

6. The method of claim 1, wherein the compounds of the analyte solution comprise at least one of metallocenes, chelate complexes of transition metals, and organometalloid halides.

7. The method of claim 1, wherein the compounds comprise at least one bond selected from B—Cl, Al—Cl, C—Cl, Si—Cl, Ge—Cl, Sn—Cl, P—Cl, As—Cl, Sb—Cl, S—Cl, Se—Cl, and Te—Cl.

8. The method of claim 1, wherein the stationary phase has one or more of the following properties:
(i) is non-protic;
(ii) is hydrophobic;
(iii) comprises particles having a diameter in the range of about 1 to about 10 micrometers;
(iv) is stable across a pH range of from about 1 to about 14;
(v) has a pore size of about from about 200 to about 300 Angstrom; and
(vi) has a specific surface area of about 100 to about 140 m²/g.

9. The method of claim 1, wherein the liquid phase comprises one or more of tetrahydrofuran, diethyl ether, methyl tert-butyl ether, dioxane, di-n-butyl ether, 1,2-dimethoxyethane, diphenyl ether, diethyleneglycol dimethyl ether, triethylamine, diethylamine, n-butylamine, benzylamine, aniline, nitromethane, nitrobenzene, N-methylpyrrolidone, anisole, methylene chloride, chloroform, carbon tetrachloride, 1,2-dichloroethane, 1,2-dibromoethane, tert-butyl chloride, isopropyl chloride, trichlorofluoromethane, benzotrifluoride, fluorobenzene, chlorobenzene, bromobenzene, perfluorodecane, hexafluorobenzene, 1,2-dichlorobenzene, pentane, hexanes, heptane, n-octane, cyclohexane, methylcyclohexane, petroleum ether, benzene, toluene, xylene, ethyl acetate, acetone, dimethylsulfoxide, dimethylformamide, acetonitrile, perfluorohexane, and mixtures thereof.

10. The method of claim 1, wherein the liquid phase comprises one or more of tetrahydrofuran, methylene chloride, chloroform, toluene, hexanes, heptanes, 1,1-dichloroethane, o-dichlorobenzene, perfluorohexane, and mixtures thereof.

11. The method of claim 1, wherein the liquid phase has less than 30 ppm water.

12. The method of claim 1, wherein the liquid phase has 5 ppm or less of water.

13. The method of claim 1, wherein the flow rate of the liquid phase is in the range of from about 0.1 to about 250 ml/min.

14. The method of claim 1, wherein the eluted compounds have a resolution of greater than 1.0.

15. A method for chromatography comprising:
introducing an analyte solution comprising compounds comprising a transition metal from groups 3 to 6 into a chromatographic system comprising a liquid phase flowing through a solid stationary phase, wherein the solid stationary phase comprises graphitic carbon; and
eluting compounds from the stationary phase with a retention factor greater than zero, wherein a chromatogram of the eluted compounds shows that the compounds are substantially resolved.

16. The method of claim 15, wherein the compounds are organometallic compounds comprising a transition metal from group 3 to 5.

17. The method of claim 15, wherein the compounds of the analyte solution comprise at least one of metallocenes, and chelate complexes of transition metals.

18. The method of claim 15, wherein the stationary phase has one or more of the following properties:
(i) is non-protic;
(ii) is hydrophobic;
(iii) comprises particles having a diameter in the range of about 1 to about 10 micrometers;
(iv) is stable across a pH range of from about 1 to about 14;
(v) has a pore size of about from about 200 to about 300 Angstrom; and
(vi) has a specific surface area of about 100 to about 140 m²/g.

19. The method of claim 15, wherein the liquid phase comprises one or more of tetrahydrofuran, diethyl ether, methyl tert-butyl ether, dioxane, di-n-butyl ether, 1,2-dimethoxyethane, diphenyl ether, diethyleneglycol dimethyl ether, triethylamine, diethylamine, n-butylamine, benzylamine, aniline, nitromethane, nitrobenzene, N-methylpyrrolidone, anisole, methylene chloride, chloroform, carbon tetrachloride, 1,2-dichloroethane, 1,2-dibromoethane, tert-butyl chloride, isopropyl chloride, trichlorofluoromethane, benzotrifluoride, fluorobenzene, chlorobenzene, bromobenzene, perfluorodecane, hexafluorobenzene, 1,2-dichlorobenzene, pentane, hexanes, heptane, n-octane, cyclohexane, methylcyclohexane, petroleum ether, benzene, toluene, xylene, ethyl acetate, acetone, dimethylsulfoxide, dimethylformamide, acetonitrile, and mixtures thereof.

20. The method of claim 15, wherein the liquid phase comprises one or more of tetrahydrofuran, methylene chloride, chloroform, toluene, hexanes, heptanes, 1,1-dichloroethane, o-dichlorobenzene, perfluorohexane, and mixtures thereof.

21. The method of claim 15, wherein the liquid phase has less than 30 ppm water.

22. The method of claim 15, wherein the liquid phase has 5 ppm or less of water.

23. The method of claim 15, wherein the flow rate of the liquid phase is in the range of from about 0.1 to about 250 ml/min.

24. The method of claim 15, wherein the eluted compounds have a resolution of greater than 1.0.

25. A method for determining the purity of an analyte solution comprising:
introducing an analyte solution into a chromatographic system comprising a liquid phase flowing through a solid stationary phase, wherein the analyte solution comprises a transition metal from groups 3 to 12 and/or a metalloid from groups 13 to 16 and/or a lanthanide metal, and wherein the solid stationary phase comprises graphitic carbon;
eluting compounds from the stationary phase with a retention factor greater than zero, wherein a chromatogram shows that the eluted compounds have a resolution of greater than 1.0; and
determining the amount of the desired compound.
